(19) United States
(12) Patent Application Publication
(10) Pub. No.: US 2004/0085010 A1
(43) Pub. Date: May 6, 2004

(54) Electron emitter, drive circuit of electron emitter and method of driving electron emitter

(75) Inventors: Yukihisa Takeuchi, Nishikamo-gun (JP); Tsutomu Nanataki, Toyoake-city (JP); Iwao Ohwada, Nagoya-city (JP); Nobuyuki Kokune, Nagoya-city (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 10/405,897

(22) Filed: Apr. 2, 2003

(30) Foreign Application Priority Data
Jun. 24, 2002 (JP) 2002-183481
Oct. 1, 2002 (JP) 2002-289127

(51) Int. Cl. H01J 1/00

(52) U.S. Cl. 313/310

(57) ABSTRACT

An electron emitter has an electric field receiving member formed on a substrate, a drive electrode formed on one surface of the electric field receiving member, and a common electrode formed on the one surface of the electric field receiving member, with a slit defined between the drive electrode and the common electrode. The drive electrode is supplied with a drive signal from a pulse generation source, and the common electrode is connected to a common potential generation source (GND in the illustrated embodiment). The slit has a width d in the range from 0.1 μm to 50 μm.

### BACKGROUND OF THE INVENTION

1. Field of the Invention

The present invention relates to an electron emitter comprising a drive electrode and a common electrode formed on an electron emitter, and a slit between the drive electrode and the common electrode. Further, the present invention relates to a circuit for driving the electron emitter, and a method of driving the electron emitter.

2. Description of the Related Art

Recently, electron emitters having a drive electrode and a common electrode have been used in various applications such as field emission displays (FEDs) and backlight units. In an FED, a plurality of electron emitters are arranged in a two-dimensional array, and a plurality of fluorescent bodies are positioned at predetermined intervals in association with the respective electron emitters.

Conventional electron emitters are disclosed in Japanese laid-open patent publication No. 1-311533, Japanese laid-open patent publication No. 7-147131, Japanese laid-open patent publication No. 2000-285801, Japanese patent publication No. 46-20944, and Japanese patent publication No. 44-26125, for example. All of these disclosed electron emitters are disadvantageous in that since no dielectric body is employed in the electric field receiving member, a forming process or a micromachining process is required between facing electrodes, a high voltage needs to be applied between the electrodes to emit electrons, and a panel fabrication process is complex and entails a high panel fabrication cost.

It has been considered to make an electric field receiving member of a dielectric material. Various theories about the emission of electrons from a dielectric material have been presented in the documents: Yasuoka and Ishii, “Pulse electron source using a ferrodielectric cathode”, J. Appl. Phys., Vol. 68, No. 5, p. 546-550 (1999), V. F. Puchkarev, G. A. Mesyats, “On the mechanism of emission from the ferroelectric ceramic cathode”, J. Appl. Phys., Vol. 78, No. 9, 1 November, 1995, p. 5633-5637, and H. Riege, “Electron emission ferroelectrics—a review”, Nucl. Instr. and Meth. A340, p. 80-89 (1994). However, the principles behind an emission of electrons have not yet been established, and advantages of an electron emitter having an electric field receiving member made of a dielectric material have not been achieved.

### SUMMARY OF THE INVENTION

It is an object of the present invention to provide an electron emitter having an electric field receiving member made of a dielectric material, to provide a circuit for driving the electro emitter, and to provide a method of driving the electron emitter in which a drive electrode and a common electrode of the electron emitter are prevented from being damaged due to the emission of electrons, so that the electron emitter has a longer service life and higher reliability.

An electron emitter according to the present invention has an electric field receiving member made of a dielectric material, a drive electrode for being supplied with a drive signal, the drive electrode being formed in contact with the electric field receiving member, and a common electrode formed in contact with the electric field receiving member, with a slit defined between the drive electrode and the common electrode, the slit having a width ranging from 0.1 μm to 50 μm.

When the drive signal is supplied to the drive electrode, a plasma is generated at an electric field concentration point, and some of the electrons multiplied in the process of generating the plasma are emitted. The drive electrode, for example, may be damaged by positive ions which are generated by the plasma and impinge upon the drive electrode.

If the intensity of the electric field at the electric field concentration point is represented by E, the voltage applied between the drive electrode and the common electrode by V, and the width of the slit by d, then the intensity E of the electric field at the electric field concentration point is required to have a certain value or higher for emitting electrons. Since E=V/d, in order to increase the intensity of the electric field, the applied voltage V may be increased or the width d of the slit may be reduced.

If the applied voltage V is increased, then (1) since the withstand voltage of a drive circuit for the electron emitter needs to be increased, the drive circuit cannot be reduced in size and tends to become highly expensive, and (2) because positive ions generated by the plasma gains energy under the voltage V and impinge upon the drive electrode, the drive electrode is more liable to be damaged.

According to the present invention, the width d of the slit is reduced. The conventional electron emitters for emitting electrons under an electric field require an electric field of about 5×10⁹ V/m, and need a small slit width of 20 nm if the applied voltage is less than 100 V.

According to the present invention, since the electric field receiving member is made of a dielectric material, if the applied voltage is less than 100 V, then the width d of the slit is not required to be as small as 20 nm, but may be about 20 μm. Depending on the selected value of the applied voltage, the width d of the slit should preferably be selected in the range from 0.1 μm to 50 μm, or more preferably in the range from 0.1 μm to 10 μm. If the applied voltage is about 10 V, then the width d of the slit should preferably be selected in the range from 0.1 μm to 1 μm.

The width d of the slit should be 0.1 μm or greater because it makes it easy to form the slit and also keeps the drive electrode and the common electrode insulated from each other. The width d of the slit should be 50 μm or less, 10 μm or less, or 1 μm or less because it is effective to lower the electron emission voltage depending on the selected value of the applied voltage. With the width d of the slit selected in the above range, the drive circuit can be reduced in size and cost, and the drive electrode can be prevented from being damaged for a longer service life.

According to the present invention, the drive electrode and the common electrode may be formed on an upper surface of the electric field receiving member, and the slit may comprise a gap.

The drive electrode may be formed in contact with one side surface of the electric field receiving member, and the common electrode may be formed in contact with another side surface of the electric field receiving member. The electric field receiving member may be present in the slit.

If the slit comprises a gap, then the width of the slit increases when the drive electrode is damaged, making it difficult to keep the applied voltage low. If the electric field receiving member is present in the slit, then the width of the slit remains unchanged even when the drive electrode is damaged. As a result, electrons can be emitted stably under a constant voltage, and the electrodes can have a longer service life.

Furthermore, since the electric field receiving member is interposed between the two electrodes, the electric field receiving member can be polarized completely, emitting electrons stably and efficiently due to the inverted polarization.

If the electric field receiving member is formed in a tortuous pattern, then the area of contact between the drive electrode and the electric field receiving member and the area of contact between the common electrode and the electric field receiving member are increased for efficiently emitting electrons.

According to the present invention, there is also provided a circuit for driving an electron emitter having an electric field receiving member made of a dielectric material, a drive electrode for being supplied with a drive signal, the drive electrode being formed in contact with the electric field receiving member, and a common electrode formed in contact with the electric field receiving member, with a slit defined between the drive electrode and the common electrode, the circuit comprising a capacitor connected between a source for generating the drive signal and the drive electrode and/or between the common electrode and a source for generating a common potential.

For causing the electric field concentration point near the drive electrode to emit electrons which serve as a source (trigger) for generating a plasma by applying a voltage to the drive electrode, it is necessary to apply a sharp voltage change to the drive electrode. Usually, the waveform of the voltage applied between the drive electrode and the common electrode is of a gradual nature as a whole due to the CR time constant based on the electrostatic capacitance and other resistive component between the drive electrode and the common electrode. However, the voltage level that rises or falls steeply is low, and the voltage waveform until the voltage level reaches 95%, for example, of a prescribed voltage (the rising or falling voltage of the source for generating the drive signal) is gradual. An attempt is made to obtain an apparent steep voltage change over a required voltage level by increasing the amplitude of the drive signal.

According to the above process, if the electron emitter is regarded as a type of capacitor then since the voltage (the applied voltage) applied between the drive electrode and the common electrode is increased, electrons are emitted by a high-speed charging with a large current. However, a subsequent application of a high voltage causes en excessive current to flow, tending to damage the drive electrode owing to the Joule heat generated thereby and positive ions impinging upon the drive electrode.

According to the present invention, with the above arrangement, since the electrostatic capacitance of the capacitor is connected in series to the electrostatic capacitance formed by the drive electrode and the common electrode, the overall capacitance becomes smaller than the electrostatic capacitance formed by the drive electrode and the common electrode, and the CR time constant becomes smaller accordingly. As a result, there is obtained a voltage change going quickly up or down to a voltage level (e.g., 95% of the prescribed voltage) which is required for emitting electrons as the waveform of the applied voltage, so that the electron emission voltage can be lowered. As no high voltage needs to be applied to the electron emitter, it is possible to suppress an excessive current.

According to the present invention, there is also provided a circuit for driving an electron emitter having an electric field receiving member made of a dielectric material, a drive electrode for being supplied with a drive signal, the drive electrode being formed in contact with the electric field receiving member, and a common electrode formed in contact with the electric field receiving member, with a slit defined between the drive electrode and the common electrode, the circuit comprising a current-suppressing resistive device connected between a source for generating the drive signal and the drive electrode and/or between the common electrode and a source for generating a common potential.

With the above arrangement, it is possible to suppress an excessive current flowing in the electron emitter, thus reducing damage to the drive electrode.

Preferably, the resistive device has nonlinear resistance characteristics. For example, the resistive device should comprise a MOSFET. The resistive device thus arranged is effective to prevent the voltage applied between the drive electrode and the common electrode from changing gradually, and to cause the applied voltage to change steeply.

The source for generating the drive signal may repeat a step comprising a preparatory period in which a positive voltage is applied to the drive electrode to polarize the electric field receiving member and an electron emission period in which a negative voltage is applied to the drive electrode to invert the polarization of the electric field receiving member for emitting electrons.

In the preparatory period, the electric field receiving member of dielectric material is polarized. In the subsequent electron emission period, the polarization of the electric field receiving member is inverted, causing electrons to be emitted from the slit. Specifically, those dipole moments which are charged in the interface between the electric field receiving member whose polarization has been inverted and the drive electrode to which the negative voltage is applied extract emitted electrons when the direction of the dipole moments is changed. According to the present invention, therefore, electrons can efficiently be emitted from the electron emitter. The plasma referred to above is generated using the emitted electrons as a source (trigger).

If the negative voltage has an absolute value greater than the positive voltage, then it is possible to reduce electric power consumption and to prevent the electrodes from being damaged due to the application of the positive voltage.

According to the present invention, the circuit for driving the electron emitter may further comprise a switching circuit for arbitrarily switching between a first cycle and a second cycle, the first cycle including at least one step which comprises a preparatory period in which a positive voltage is applied to the drive electrode to polarize the electric field receiving member and an electron emission period in which a negative voltage is applied to the drive electrode to invert the polarization of the electric field receiving member for emitting electrons from the drive electrode, and the second cycle including at least one step which comprises a preparatory period in which a negative voltage is applied to the drive electrode to polarize the electric field receiving member and an electron emission period in which a positive voltage is applied to the drive electrode to invert the polarization of the electric field receiving member for emitting electrons from the common electrode.

If the electron emitter were energized in the first cycle only, then positive ions generated by the plasma would impinge upon the drive electrode, damaging the drive electrode. Therefore, the durability of the electron emitter would hinge only upon damage to the drive electrode. If the electron emitter were energized in the second cycle only, then the durability of the electron emitter would hinge only upon damage to the common electrode. If the first cycle and the second cycle are switched or selected as desired, then damage which would otherwise be caused to one of the electrodes is distributed to both the electrodes, with the result that the electrodes will have a longer service life.

The circuit for driving the electron emitter may further comprise a pulse generation circuit for applying a voltage which has a polarity opposite to the voltage applied to the drive voltage, to the common electrode at least in the electron emission period.

If the common electrode is under a constant potential and the drive electrode is supplied with the drive signal, then the dynamic range of the voltage applied between the drive electrode and the common electrode is determined by the withstand voltage of the source for generating the drive signal.

However, the pulse generation circuit is effective to increase the dynamic range of the voltage applied between the drive electrode and the common electrode to a withstand voltage which is the sum of the withstand voltage of the source for generating the drive signal and the withstand voltage of the pulse generation circuit. Therefore, a circuit having a withstand voltage which is one-half the above normal withstand voltage may be used as the source for generating the drive signal, so that the drive circuit can be made smaller in size and lower in cost.

Preferably, the electron emission period ranges from 5 to 10 μsec., and the preparatory period is longer than the electron emission period.

If a time constant determined by an electrostatic capacitance and other resistive component between the drive electrode and the common electrode is represented by τ and the electron emission period by T, then the time constant τ and the electron emission period T satisfy the following relationship:

0≦T≦3τ.

Since the electron emission period is the period of a sharp voltage change which contributes to electron emission, a wasteful current supply is eliminated, resulting in a reduction of electric power consumption, and an emission of excessive electrons is suppressed.

The circuit for driving the electron emitter may further comprise a switching element connected in series to the electron emitter, wherein if a time constant determined by an electrostatic capacitance and other resistive component between the drive electrode and the common electrode is represented by τ, the electron emission period by T, and an on-time of the switching element by t, then the time constant τ, the electron emission period T, and the on-time t satisfy the following relationship:

0≦t≦3τ≦T.

In the above arrangement, if an on-time of the switching element for emitting electrons is represented by t1, and a subsequent off-time of the switching element for keeping electrons emitted and suppressing a current flowing into the drive electrode by t2, then the time constant τ, the electron emission period T, the on-time t1, and the off-time t2 satisfy the following relationship:

0≦t1≦3τ<t2≦T.

In the on-time t1 of the switching element, a sharp voltage change contributing to electron emission occurs, and in the off-time t2, the electron emission is kept and the current flowing into the drive electrode is suppressed. Therefore, a wasteful current supply is eliminated, resulting in a reduction of electric power consumption, and an emission of excessive electrons is suppressed.

The circuit for driving the electron emitter may further comprise at least one parallel circuit connected in series to the electron emitter, the parallel circuit comprising a resistor and a capacitor which are connected parallel to each other, wherein the electron emission period includes an effective electron emission period from the start of a pulse of the drive signal to the time when the level of the voltage applied to the electron emitter reaches a divided level on the electron emitter of the amplitude of the drive signal.

Since the capacitor of the parallel circuit is connected in series to the electrostatic capacitance formed by the drive electrode and the common electrode of the electron emitter, the overall capacitance becomes smaller than the electrostatic capacitance formed by the drive electrode and the common electrode, and the CR time constant becomes smaller accordingly. As a result, there is obtained a voltage change going quickly up or down to a voltage level which is required for emitting electrons as the applied voltage, so that the electron emission voltage can be lowered.

Inasmuch as the absolute value of the applied voltage is reduced at the same time that the electron emission period is finished, an excessive current is suppressed, reducing damage to the drive electrode and the common electrode for a longer service life thereof.

According to the present invention, there is further provided a method of driving an electron emitter having an electric field receiving member made of a dielectric material, a drive electrode for being supplied with a drive signal, the drive electrode being formed in contact with the electric field receiving member, and a common electrode formed in contact with the electric field receiving member, with a slit defined between the drive electrode and the common electrode, the method comprising repeating a step which comprises a preparatory period in which a positive voltage is applied to the drive electrode to polarize the electric field receiving member and an electron emission period in which a negative voltage is applied to the drive electrode to invert the polarization of the electric field receiving member for emitting electrons. The method is effective to emit electrons efficiently from the electron emitter.

The method may further comprise switching between a first cycle and a second cycle, the first cycle including at least one step which comprises a preparatory period in which a positive voltage is applied to the drive electrode to polarize the electric field receiving member and an electron emission period in which a negative voltage is applied to the drive electrode to invert the polarization of the electric field receiving member for emitting electrons from the drive electrode, and the second cycle including at least one step which comprises a preparatory period in which a negative voltage is applied to the drive electrode to polarize the electric field receiving member and an electron emission period in which appositive voltage is applied to the drive electrode to invert the polarization of the electric field receiving member for emitting electrons from the common electrode. By arbitrarily switching between the first cycle and the second cycle, damage which would otherwise be caused to one of the electrodes is distributed to both the electrodes, with the result that the electrodes will have a longer service life.

The method may further comprise applying a voltage having a polarity opposite to the voltage applied to the drive voltage, to the common electrode at least in the electron emission period.

Thus, the dynamic range of the applied voltage can be increased, and hence the withstand voltages of the source for generating the drive signal and the source for generating a common potential can be reduced, so that the drive circuit can be made smaller in size and lower in cost.

In the method, the electron emission period should preferably range from 5 to 10 μsec., and the preparatory period should preferably be longer than the electron emission period.

In the method, if a time constant determined by an electrostatic capacitance and other resistive component between the drive electrode and the common electrode is represented by τ and the electron emission period by T, then the time constant τ and the electron emission period T may satisfy the following relationship:

0≦T≦3τ.

Since the electron emission period is the period of a sharp voltage change which contributes to electron emission, a wasteful current supply is eliminated, resulting in a reduction of electric power consumption, and an emission of excessive electrons is suppressed.

In the method, a switching element may be connected in series to the electron emitter, and if a time constant determined by an electrostatic capacitance and other resistive component between the drive electrode and the common electrode is represented by τ, the electron emission period by T, and an on-time of the switching element by t, then the time constant τ, the electron emission period T, and the on-time t may satisfy the following relationship:

0≦t≦3τ≦T.

Furthermore, if an on-time of the switching element for emitting electrons is represented by t1, and a subsequent off-time of the switching element for keeping electrons emitted and suppressing a current flowing into the drive electrode by t2, then the time constant τ, the electron emission period T, the on-time t1, and the off-time t2 may satisfy the following relationship:

0≦t1≦3τ<t2≦T.

In the on-time t1 of the switching element, a sharp voltage change contributing to electron emission occurs, and in the off-time t2, the electron emission is kept and the current flowing into the drive electrode is suppressed. Therefore, a wasteful current supply is eliminated, resulting in a reduction of electric power consumption, and an emission of excessive electrons is suppressed.

In the method, at least one parallel circuit is connected in series to the electron emitter, the parallel circuit comprising a resistor and a capacitor which are connected parallel to each other, and wherein the electron emission period includes an effective electron emission period from the start of a pulse of the drive signal to the time when the level of the voltage applied to the electron emitter reaches a divided level on the electron emitter of the amplitude of the drive signal.

The above and other objects, features, and advantages of the present invention will become more apparent from the following description of preferred embodiments when taken in conjunction with the accompanying drawings.

### BRIEF DESCRIPTION OF THE DRAWINGS

FIG. 1 is a view showing an electron emitter according to an embodiment of the present invention (an electron emitter according to a first specific example);

FIG. 2 is a plan view showing electrodes of the electron emitter according to the first specific example;

FIG. 3 is a waveform diagram showing a drive signal outputted from a pulse generation source;

FIG. 4 is a view illustrative of operation when a positive voltage is applied to a drive electrode;

FIG. 5 is a view illustrative of operation when a negative voltage is applied to the drive electrode (the principles of an emission of electrons);

FIG. 6 is a view showing major parts of an electron emitter according to a second specific example;

FIG. 7 is a view showing the electron emitter according to the second specific example, with a drive electrode partly damaged;

FIG. 8 is a view illustrative of the principles of an emission of electrons from the electron emitter according to the second specific example;

FIG. 9 is a plan view showing a first modification of the electron emitter according to the second specific example;

FIG. 10 is a cross-sectional view taken along a line X-X of FIG. 9;

FIG. 11 is a cross-sectional view showing a second modification of the electron emitter according to the second specific example;

FIG. 12 is a cross-sectional view showing a third modification of the electron emitter according to the second specific example;

FIG. 13 is a plan view showing the third modification of the electron emitter according to the second specific example;

FIG. 14 is a view showing a sample used in an experimental example;

FIG. 15A is a waveform diagram showing a drive signal;

FIG. 15B is a waveform diagram showing a current flowing from a common electrode to GND;

FIG. 15C is a waveform diagram showing a current flowing from a pulse generation source to a drive electrode;

FIG. 15D is a waveform diagram showing a current flowing from an electron collector electrode to GND;

FIG. 15E is a waveform diagram showing a voltage applied between the drive electrode and the common electrode;

FIG. 16A is a waveform diagram showing a drive signal outputted from a pulse generation source;

FIG. 16B is a waveform diagram showing a voltage applied to an electron emitter;

FIG. 17 is a circuit diagram showing a drive circuit according to a first specific example;

FIG. 18 is a waveform diagram showing a drive signal outputted from a pulse generation source in the drive circuit according to the first specific example;

FIG. 19 is a circuit diagram showing a drive circuit according to a second specific example;

FIG. 20A is a waveform diagram showing a drive signal outputted from a pulse generation source in the drive circuit according to the second specific example;

FIG. 20B is a waveform diagram showing a voltage applied to an electron emitter;

FIG. 21 is a circuit diagram showing a first modification of the drive circuit according to the second specific example;

FIG. 22 is a circuit diagram showing a second modification of the drive circuit according to the second specific example;

FIG. 23 is a circuit diagram showing a drive circuit according to a third specific example (and a drive circuit according to a fourth specific example);

FIG. 24A is a waveform diagram showing a drive signal outputted from a pulse generation source in the drive circuit according to the third specific example;

FIG. 24B is a timing chart showing an on-time of a switching element;

FIG. 25A is a waveform diagram showing a drive signal outputted from a pulse generation source in a drive circuit according to a fourth specific example;

FIG. 25B is a timing chart showing an on-time and an off-time of a switching element;

FIG. 26 is a circuit diagram showing a drive circuit according to a fifth specific example;

FIG. 27A is a waveform diagram showing a drive signal outputted from a pulse generation source in the drive circuit according to the fifth specific example;

FIG. 27B is a waveform diagram showing a voltage applied to an electron emitter;

FIG. 28 is a circuit diagram showing a modification of the drive circuit according to the fifth specific example;

FIG. 29 is a circuit diagram showing a drive circuit according to a sixth specific example;

FIG. 30A is a waveform diagram showing a drive signal outputted from a pulse generation source in the drive circuit according to the sixth specific example;

FIG. 30B is a waveform diagram showing a drive signal outputted from a pulse generation circuit;

FIG. 31 is a circuit diagram showing a drive circuit according to a seventh specific example;

FIG. 32A is a waveform diagram showing a drive signal outputted from a second pulse generation source in the drive circuit according to the seventh specific example;

FIG. 32B is a waveform diagram showing a drive signal outputted from a second pulse generation source;

FIG. 32C is a waveform diagram showing a drive signal outputted from a first pulse generation circuit;

FIG. 32D is a waveform diagram showing a drive signal outputted from a second pulse generation circuit; and

FIG. 33 is a diagram showing a preferred arrangement in which an electron emitter according to the present embodiment is applied to a pixel of a display.

### DESCRIPTION OF THE PREFERRED EMBODIMENTS

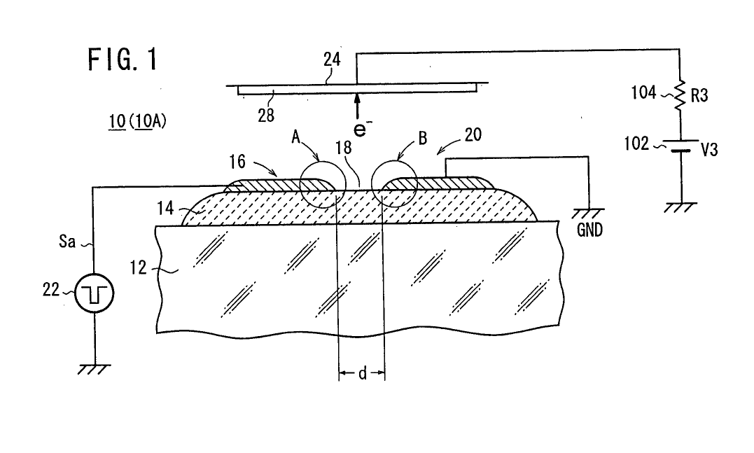

Embodiments of an electron emitter, a circuit for driving the electron emitter, and a method of driving the electron emitter according to the present invention will be described below with reference to FIGS. 1 through 33.

Generally, electron emitters can be used in displays, electron beam irradiation apparatus, light sources, alternatives to LEDs, and electronic parts manufacturing apparatus.

An electron beam in an electron beam irradiation apparatus has a higher energy and a better absorption capability than ultraviolet rays in ultraviolet ray irradiation apparatus that are presently in widespread use. Electron emitters are used to solidify insulating films in superposing wafers for semiconductor devices, harden printing inks without irregularities for drying prints, and sterilize medical devices while being kept in packages.

Electron emitters are also used as high-luminance, high-efficiency light sources for use in projectors, for example.

Electron emitters are also used as alternatives to LEDs in chip light sources, traffic signal devices, and backlight units for small-size liquid-crystal display devices for cellular phones.

Electron emitters are also used in electronic parts manufacturing apparatus including electron beam sources for film growing apparatus such as electron beam evaporation apparatus, electron sources for generating a plasma (to activate a gas or the like) in plasma CVD apparatus, and electron sources for decomposing gases.

As shown in FIG. 1, an electron emitter 10 according to an embodiment of the present invention has an electric field receiving member 14 formed on a substrate 12, a drive electrode 16 formed on one surface of the electric field receiving member 14, and a common electrode 20 formed on the same surface of the electric field receiving member 14 with a slit 18 defined between the drive electrode 16 and the common electrode 20. The drive electrode 16 is supplied with a drive signal Sa from a pulse generation source 22, and the common electrode 20 is connected to a common potential generation source (GND in this example).

For using the electron emitter 10 as a pixel of a display, an electron collector electrode 24 is positioned above the electric field receiving member 14 to face the slit 18, and the electron collector electrode 24 is coated with a fluorescent layer 28. A bias voltage source 102 (a bias voltage of V3) is connected to the electron collector electrode 24 through a resistor 104 (a resistance of R3).

The electron emitter 10 according to the present embodiment is placed in a vacuum space. As shown in FIG. 1, the electron emitter 10A has electric field concentration points A, B. These points A, B can be defined as a triple point where an electrode, a dielectric material, and a vacuum are present at one point.

The vacuum level in the atmosphere should preferably in the range from 10² to 10⁻⁶ Pa and more preferably in the range from 10⁻³ to 10⁻⁵ Pa.

The reason for the above range is that in a lower vacuum, many gas molecules would be present in the space, and (1) a plasma can easily be generated and, if the plasma were generated excessively, many positive ions thereof would impinge upon the drive electrode 16 and damage the same, and (2) emitted electrons would tend to impinge upon gas molecules prior to arrival at the electron collector electrode 24, failing to sufficiently excite the fluorescent layer 28 with electrons that are sufficiently accelerated under the bias voltage of V3.

In a higher vacuum, though electrons would be liable to be emitted from the electric field concentration points A, B, (1) gas molecules would be insufficient to generate a plasma, and (2) structural body supports and vacuum seals would be large in size, posing disadvantages on efforts to make the electron emitter smaller in size.

The electric field receiving member 14 is made of a dielectric material. The dielectric material should preferably have a relatively high dielectric constant, e.g., a dielectric constant of 1000 or higher. Dielectric materials of such a nature may be ceramics including barium titanate, lead zirconate, lead magnesium niobate, lead nickel niobate, lead zinc niobate, lead manganese niobate, lead magnesium tantalate, lead antimony stannate, lead titanate, barium titanate, lead magnesium tungstenate, lead cobalt niobate, etc. or a material whose principal component contains 50 weight % or more of the above compounds, or such ceramics to which there is added an oxide of lanthanum, calcium, strontium, molybdenum, tungsten, barium, niobium, zinc, nickel, manganese, or the like, or a combination of these materials, or any of other compounds.

For example, a two-component material nPMN-mPT (n, m represent molar ratios) of lead magnesium niobate (PMN) and lead titanate (PT) has its Curie point lowered for a larger specific dielectric constant at room temperature if the molar ratio of PMN is increased.

Particularly, a dielectric material where n=0.85-1.0 and m=1.0-n is preferable because its specific dielectric constant is 3000 or higher. For example, a dielectric material where n=0.91 and m=0.09 has a specific dielectric constant of 15000 at room temperature, and a dielectric material where n=0.95 and m=0.05 has a specific dielectric constant of 20000 at room temperature.

For increasing the specific dielectric constant of a three-component dielectric material of lead magnesium niobate (PMN), lead titanate (PT), and lead zirconate (PZ), it is preferable to achieve a composition close to a morphotropic phase boundary (MPB) between a tetragonal system and a quasi-cubic system or a tetragonal system and a rhombohedral system, as well as to increase the molar ratio of PMN. For example, a dielectric material where PMN:PT:PZ=0.375:0.375:0.25 has a specific dielectric constant of 5500, and a dielectric material where PMN:PT:PZ=0.5:0.375:0.125 has a specific dielectric constant of 4500, which is particularly preferable. Furthermore, it is preferable to increase the dielectric constant by introducing a metal such as platinum into these dielectric materials within a range to keep them insulative. For example, a dielectric material may be mixed with 20 weight % of platinum.

The electric field receiving member 14 may be in the form of a piezoelectric/electrostrictive layer or an anti-ferrodielectric layer. If the electric field receiving member 14 comprises a piezoelectric/electrostrictive layer, then it may be made of ceramics such as lead zirconate, lead magnesium niobate, lead nickel niobate, lead zinc niobate, lead manganese niobate, lead magnesium tantalate, lead antimony stannate, lead titanate, barium titanate, lead magnesium tungstenate, lead cobalt niobate, or the like or a combination of any of these materials.

The electric field receiving member 14 may be made of chief components including 50 weight % or more of any of the above compounds. Of the above ceramics, the ceramics including lead zirconate is most frequently used as a constituent of the piezoelectric/electrostrictive layer of the electric field receiving member 14.

If the piezoelectric/electrostrictive layer is made of ceramics, then lanthanum, calcium, strontium, molybdenum, tungsten, barium, niobium, zinc, nickel, manganese, or the like, or a combination of these materials, or any of other compounds may be added to the ceramics.

For example, the piezoelectric/electrostrictive layer should preferably be made of ceramics including as chief components lead magnesium niobate, lead zirconate, and lead titanate, and also including lanthanum and strontium.

The piezoelectric/electrostrictive layer may be dense or porous. If the piezoelectric/electrostrictive layer is porous, then it should preferably have a porosity of 40% or less.

If the electric field receiving member 14 is in the form of an anti-ferrodielectric layer, then the anti-ferrodielectric layer may be made of lead zirconate as a chief component, lead zirconate and lead stannate as chief components, lead zirconate with lanthanum oxide added thereto, or lead zirconate and lead stannate as components with lead zirconate and lead niobate added thereto.

The anti-ferrodielectric layer may be porous. If the anti-ferrodielectric layer is porous, then it should preferably have a porosity of 30% or less.

The electric field receiving member 14 may be formed on the substrate 12 by any of various thick-film forming processes including screen printing, dipping, coating, electrophoresis, etc., or any of various thin-film forming processes including an ion beam process, sputtering, vacuum evaporation, ion plating, chemical vapor deposition (CVD), plating, etc.

In the present embodiment, the electric field receiving member 14 is formed on the substrate 12 by any of various thick-film forming processes including screen printing, dipping, coating, electrophoresis, etc.

These thick-film forming processes are capable of providing good piezoelectric operating characteristics as the electric field receiving member 14 can be formed using a paste, a slurry, a suspension, an emulsion, a sol, or the like which is chiefly made of piezoelectric ceramic particles having an average particle diameter ranging from 0.01 to 5 μm, preferably from 0.05 to 3 μm.

In particular, electrophoresis is capable of forming a film at a high density with high shape accuracy, and has features described in technical documents such as “Electrochemical and industrial physical chemistry, Vol. 53. No. 1 (1985), p. 63-68, written by Kazuo Anzai”, and “1st electrophoresis high-degree ceramic forming process research/discussion meeting, collected preprints (1998), p. 5-6, p. 23-24”. Any of the above processes may be chosen in view of the required accuracy and reliability.

The drive electrode 16 is made of materials as described below. The drive electrode 16 is made of a conductor which is resistant to a high-temperature oxidizing atmosphere, e.g., a metal, an alloy, a mixture of insulative ceramics and a metal, or a mixture of insulative ceramics and an alloy. Preferably, the drive electrode 16 should be chiefly composed of a precious metal having a high melting point, e.g., platinum, palladium, rhodium, molybdenum, or the like, or an alloy of silver and palladium, silver and platinum, platinum and palladium, or the like, or a cermet of platinum and ceramics. Further preferably, the drive electrode 16 should be made of platinum only or a material chiefly composed of a platinum-base alloy. The electrode should preferably be made of carbon or a graphite-base material, e.g., diamond thin film, diamond-like carbon, or carbon nanotube. Ceramics to be added to the electrode material should preferably have a proportion ranging from 5 to 30 volume %.

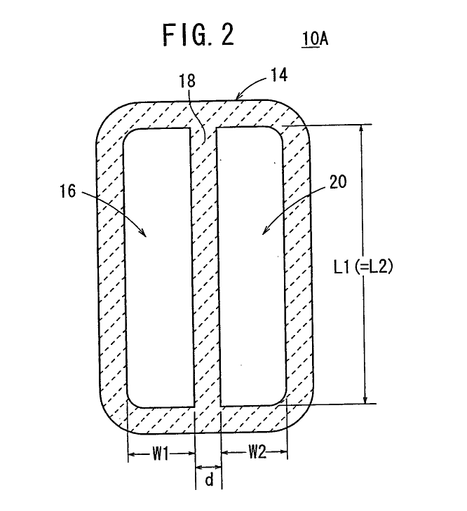

The drive electrode 16 may be made of any of the above materials by an ordinary film forming process which may be any of various thick-film forming processes including screen printing, spray coating, dipping, coating, electrophoresis, etc., or any of various thin-film forming processes including sputtering, an ion beam process, vacuum evaporation, ion plating, CVD, plating, etc. As shown FIG. 2, the drive electrode 16 has a width W1 of 2 mm and a length L1 of 5 mm. The drive electrode 16 has a thickness of 20 μm or less, or preferably 5 μm or less.

The common electrode 20 is made of the same material by the same process as the drive electrode 16. Preferably, the common electrode 20 is made by any of the above thick-film forming processes. As shown in FIG. 2, as with the drive electrode 16, the common electrode 20 has a width W2 of 2 mm and a length L2 of 5 mm.

The substrate 12 should preferably be made of an electrically insulative material in order to electrically isolate the wire electrically connected to the drive electrode 16 and the wire electrically connected to the common electrode 20 from each other.

The substrate 12 may be made of a highly heat-resistant metal or a metal material such as an enameled metal whose surface is coated with a ceramic material such as glass or the like. However, the substrate 12 should preferably be made of ceramics.

Ceramics which the substrate 12 is made of include stabilized zirconium oxide, aluminum oxide, magnesium oxide, titanium oxide, spinel, mullite, aluminum nitride, silicon nitride, glass, or a mixture thereof. Of these ceramics, aluminum oxide or stabilized zirconium oxide is preferable from the standpoint of strength and rigidity. Particularly preferable is stabilized zirconium oxide because its mechanical strength is relatively high, its tenacity is relatively high, and its chemical reaction with the drive electrode 16 and the common electrode 20 is relatively small. Stabilized zirconium oxide includes stabilized zirconium oxide and partially stabilized zirconium oxide. Stabilized zirconium oxide does not develop a phase transition as it has a crystalline structure such as a cubic system.

Zirconium oxide develops a phase transition between a monoclinic system and a tetragonal system at about 1000° C. and is liable to suffer cracking upon such a phase transition. Stabilized zirconium oxide contains 1 to 30 mol % of a stabilizer such as calcium oxide, magnesium oxide, yttrium oxide, scandium oxide, ytterbium oxide, cerium oxide, or an oxide of a rare earth metal. For increasing the mechanical strength of the substrate 12, the stabilizer should preferably contain yttrium oxide. The stabilizer should preferably contain 1.5 to 6 mol % of yttrium oxide, or more preferably 2 to 4 mol % of yttrium oxide, and furthermore should preferably contain 0.1 to 5 mol % of aluminum oxide.

The crystalline phase may be a mixed phase of a cubic system and a monoclinic system, a mixed phase of a tetragonal system and a monoclinic system, a mixed phase of a cubic system, a tetragonal system, and a monoclinic system, or the like. The main crystalline phase which is a tetragonal system or a mixed phase of a tetragonal system and a cubic system is optimum from the standpoints of strength, tenacity, and durability.

If the substrate 12 is made of ceramics, then the substrate 12 is made up of a relatively large number of crystalline particles. For increasing the mechanical strength of the substrate 12, the crystalline particles should preferably have an average particle diameter ranging from 0.05 to 2 μm, or more preferably from 0.1 to 1 μm.

Each time the electric field receiving member 14, the drive electrode 16, or the common electrode 20 is formed, the assembly is heated (sintered) into a structure integral with the substrate 12. After the electric field receiving member 14, the drive electrode 16, and the common electrode 20 are formed, they may simultaneously be sintered so that they may simultaneously be integrally coupled to the substrate 12. Depending on the process by which the drive electrode 16 and the common electrode 20 are formed, they may not be heated (sintered) so as to be integrally combined with the substrate 12.

The sintering process for integrally combining the substrate 12, the electric field receiving member 14, the drive electrode 16, and the common electrode 20 may be carried out at a temperature ranging from 500 to 1400° C., preferably from 1000 to 1400° C. For heating the electric field receiving member 14 which is in the form of a film, the electric field receiving member 14 should be sintered together with its evaporation source while their atmosphere is being controlled.

The electric field receiving member 14 may be covered with an appropriate member for preventing the surface thereof from being directly exposed to the sintering atmosphere when the electric field receiving member 14 is sintered. The covering member should preferably be made of the same material as the substrate 12.

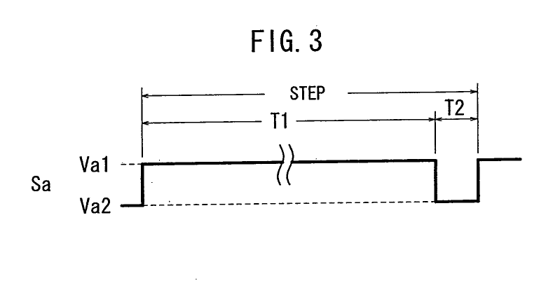

The principles of electron emission of the electron emitter 10 will be described below with reference to FIGS. 1 through 5. As shown in FIG. 3, the drive signal Sa outputted from the pulse generation source 22 has repeated steps each including a period in which a positive voltage Va1 is outputted (preparatory period T1) and a period in which a negative voltage Va2 is outputted (electron emission period T2).

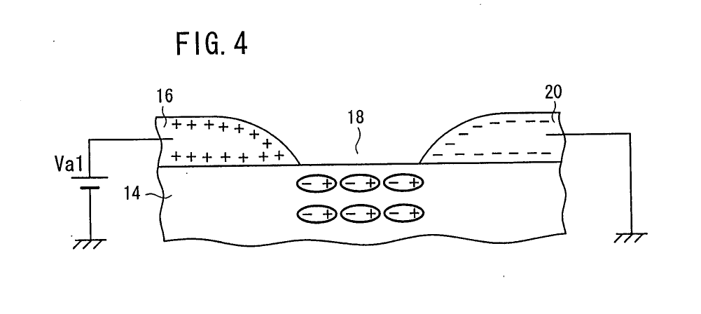

The preparatory period T1 is a period in which the positive voltage Va1 is applied to the drive electrode 16 to polarize the electric field receiving member 14, as shown in FIG. 4. The positive voltage Va1 may be a DC voltage, as shown in FIG. 3, but may be a single pulse voltage or a succession of pulse voltages. In the preparatory period T1, the electric field receiving member 14 is polarized by the positive voltage Va1 which is smaller than the absolute value of the negative voltage Va2 for electron emission in order to prevent the power consumption from being unduly increased when the positive voltage Va1 is applied and also to prevent the drive electrode 16 from being damaged. Therefore, the preparatory period T1 should preferably be longer than the electron emission period T2 for sufficient polarization. For example, the preparatory period T1 should preferably be in the range from 100 to 150 μsec.

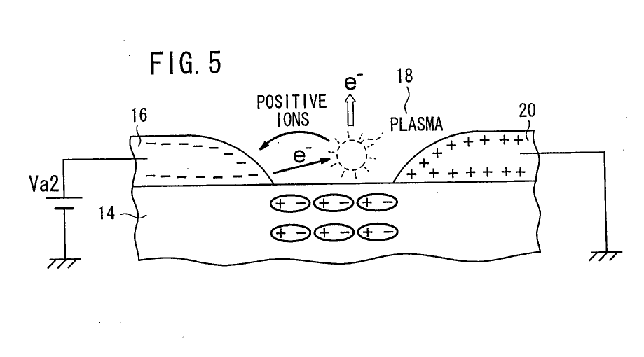

The electron emission period T2 is a period in which the negative voltage Va2 is applied to the drive electrode 16. When the negative voltage Va2 is applied to the drive electrode 16 as shown in FIG. 5, the polarization of the electric field receiving member 14 is inverted, causing electrons to be emitted from the slit 18. Specifically, those dipole moments which are charged in the interface between the electric field receiving member 14 whose polarization has been inverted and the drive electrode 16 to which the negative voltage Va2 is applied extract emitted electrons when the direction of these dipole moments is changed. The electron emission period T2 should preferably be in the range from 5 to 10 μsec.

As shown in FIG. 5, the emitted electrons are directed toward the common electrode 20, generating a plasma at the electric field concentration point B (see FIG. 1) near the common electrode 20. In the process of generating the plasma, the number of electrons are exponentially increased and some of the electrons are directed toward the electron collector electrode 24. The electrons impinge upon the fluorescent layer 28 to excite the fluorescent layer 28 to emit light.

In the example shown in FIG. 3, the preparatory period T1 is 128 μsec., the positive voltage Va1 is 30 V, the electron emission period T2 is 7 μsec., and the negative voltage Va2 is −100 V.

In the electron emission period T2, since positive ions generated by the plasma are directed toward the electric field concentration point A (see FIG. 1) near the drive electrode 16, these positive ions impinge upon the drive electrode 16, tending to damage the drive electrode 16.

If the drive electrode 16 has a conventional conical shape, then the tip of the electrode would be deformed into a round shape due to damage, requiring an increased electron emission voltage. One solution would be to make the electrode of a material having a high melting point such as molybdenum or the like, but the electrode itself would become highly expensive, resulting in an increase in the cost required to manufacture the electron emitter. According to another solution, a separate gate electrode or the like would be provided to prevent positive ions from concentrating and impinging upon the drive electrode 16. This approach would be problematic in that the electrode structure would be complicated and the cost required to manufacture the electron emitter would tend to become high.

According to the present embodiment, various specific examples described below are employed to reduce the size and cost of the electron emitter, lower the electron emission voltage, and minimize damage to the drive electrode 16 (and the common electrode 20) for a longer service life thereof.

In an electron emitter 10A according to a first specific example, as shown in FIG. 2, the width d of the slit 18 between the drive electrode 16 and the common electrode 20 is reduced to lower the electron emission voltage.

If the intensity of the electric field at the electric field concentration point B is represented by E, the voltage applied between the drive electrode 16 and the common electrode 20 by Va, and the width of the slit 18 by d, then the intensity E of the electric field at the electric field concentration point B, which is required to have a certain value or higher for emitting electrons, is indicated by E=Va/d. In order to increase the intensity E of the electric field, the applied voltage Va may be increased or the width d of the slit 18 may be reduced.

If the applied voltage Va is increased, then (1) since the withstand voltage of a drive circuit for the electron emitter needs to be increased, the drive circuit cannot be reduced in size and tends to become highly expensive, and (2) because positive ions generated by the plasma gains energy under the voltage V and impinge upon the drive electrode 16, the drive electrode 16 is more liable to be damaged.

According to the first specific example, therefore, the width d of the slit 18 is reduced. The conventional electron emitters for emitting electrons under an electric field require an electric field of about 5×10⁹ V/m, and need a small slit width of 20 nm if the applied voltage Va is less than 100 V.

According to the first specific example, since the electric field receiving member 14 is made of a dielectric material, if the applied voltage Va is less than 100 V, then the width d of the slit 18 is not required to be as small as 20 nm, but may be about 20 μm. Depending on the selected value of the applied voltage Va, the width d of the slit 18 should preferably be selected in the range from 0.1 μm to 50 μm, or more preferably in the range from 0.1 μm to 10 μm. If the applied voltage Va is about 10 V, then the width d of the slit 18 should preferably be selected in the range from 0.1 μm to 1 μm.

The width d of the slit 18 should be 0.1 μm or greater because it makes it easy to form the slit 18 and also keeps the drive electrode 16 and the common electrode 20 insulated from each other. The width d of the slit 18 should be 50 μm or less, 10 μm or less, or 1 μm or less because it is effective to lower the electron emission voltage depending on the selected value of the applied voltage Va. With the width d of the slit 18 selected in the above range, the drive circuit can be reduced in size and cost, and the drive electrode 16 can be prevented from being damaged for a longer service life.

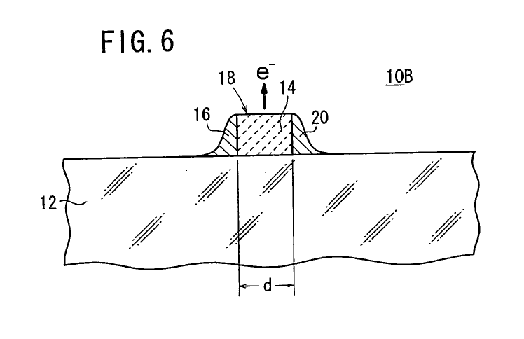

An electron emitter 10B according to a second specific example will be described below with reference to FIGS. 6 through 8.

With the electron emitter 10A according to the first specific example, as shown in FIG. 2, the drive electrode 16 and the common electrode 20 are formed on one surface of the electric field receiving member 14, with the slit 18 being defined as a gap.

As damage to the drive electrode 16 of the electron emitter 10A progresses significantly, the width d of the slit 18 gradually increases. According to the above equation E=V/d, in order to obtain a certain electric field intensity, it is necessary to increase the voltage (the applied voltage Va) for electron emission as the width d of the slit 18 increases.

As shown in FIG. 6, the electron emitter 10B according to the second specific example has an electric field receiving member 14 formed on the substrate 12, the electric field receiving member 14 having a width d in the range from 0.1 to 50 μm, a drive electrode 16 formed on one side surface of the electric field receiving member 14, and a common electrode 20 formed on the other side surface of the electric field receiving member 14. Thus, the electric field receiving member 14 is present in the slit 18 between the drive electrode 16 and the common electrode 20, and is sandwiched between the drive electrode 16 and the common electrode 20.

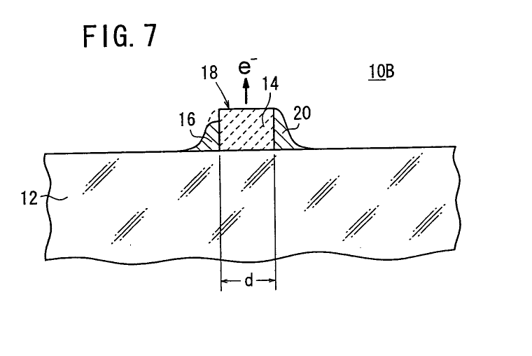

As shown in FIG. 7, the electron emitter 10B according to the second specific example is capable of emitting electrons stably under a constant voltage even if the drive electrode 16 is damaged because the distance between the drive electrode 16 and the common electrode 20, i.e., the width d of the slit 18, remains unchanged. As a result, the applied voltage Va may be lowered, and the drive electrode 16 may have a longer service life.

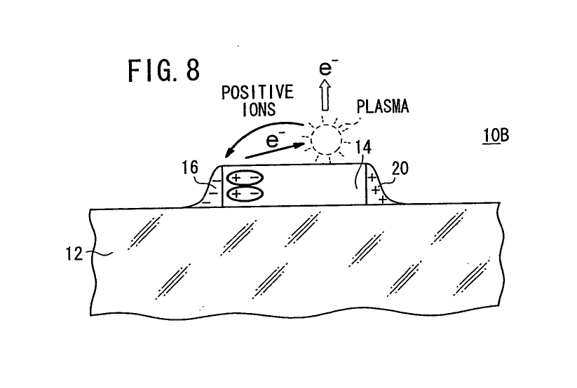

Inasmuch as the electric field receiving member 14 made of dielectric material is sandwiched between the drive electrode 16 and the common electrode 20, as shown in FIG. 8, the electric field receiving member 14 can be polarized completely, emitting electrons stably and efficiently due to the inverted polarization.

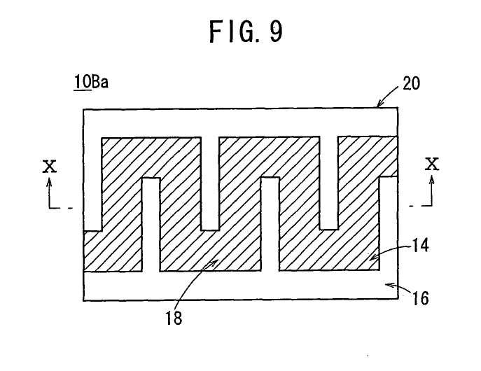

Three modifications of the electron emitter 10B according to the second specific example will be described below with reference to FIGS. 9 through 13.

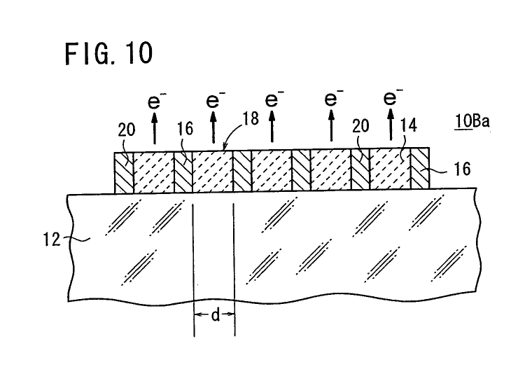

An electron emitter 10Ba according to a first modification is based on the concept of the electron emitter 10B according to the second specific example. As shown in FIGS. 9 and 10, the electron emitter 10Ba has an electric field receiving member 14 which has a tortuous shape as viewed in plan. The width d of the slit 18 between the drive electrode 16 and the common electrode 20 should preferably be in the range from 0.1 to 50 μm.

With the structure of the first modification, the electron emitter 10B is capable of emitting electrons efficiently because the area of contact between the drive electrode 16 and the electric field receiving member 14 and the area of contact between the electric field receiving member 14 and the common electrode 20 are increased.

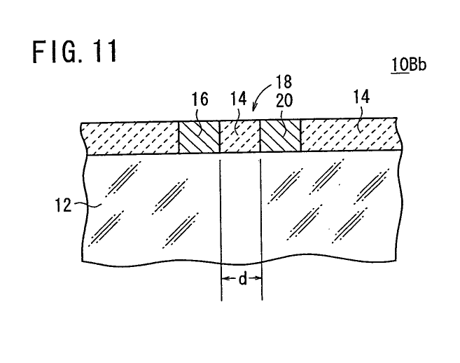

As shown in FIG. 11, an electron emitter 10Bb according to a second modification has an electric field receiving member 14 of dielectric material formed on the substrate 12, and a drive electrode 16 and a common electrode 20 which are embedded in windows defined in the electric field receiving member 14. The cross-sectional areas of the drive electrode 16 and the common electrode 20 are thus increased to reduce the resistance of the drive electrode 16 and the common electrode 20 for suppressing the generation of the Joule heat. That is, the drive electrode 16 and the common electrode 20 can be protected. The width of portion of the electric field receiving member 14 between the drive electrode 16 and the common electrode 20, i.e., the width d of the slit 18, should preferably be in the range from 0.1 to 50 μm.

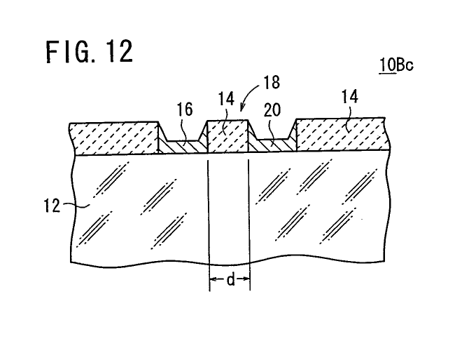

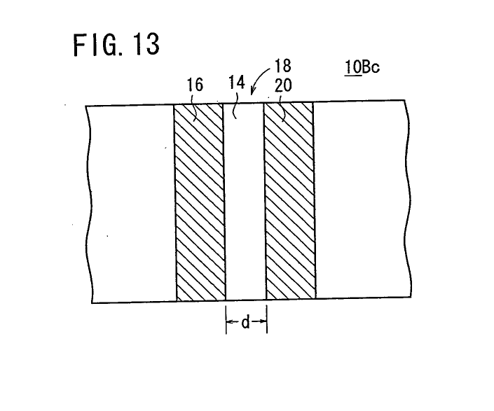

According to the second modification, the thickness of the drive electrode 16 and the common electrode 20 is essentially the same as the thickness of the electric field receiving member 14. However, the thickness of the drive electrode 16 and the common electrode 20 may be smaller than the thickness of the electric field receiving member 14 as with an electron emitter 10Bc according to a third modification shown in FIGS. 12 and 13. According to the third modification, as with the second specific example shown in FIG. 6, the drive electrode 16 and the common electrode 20 are formed in contact with side walls of a portion of the electric field receiving member 14 which is present at least in the slit 18.

According to the third modification, as with the first modification, since the drive electrode 16 and the common electrode 20 may be made of a reduced amount of metal, the drive electrode 16 and the common electrode 20 may be made of an expensive metal (e.g., platinum or gold) for improved characteristics.

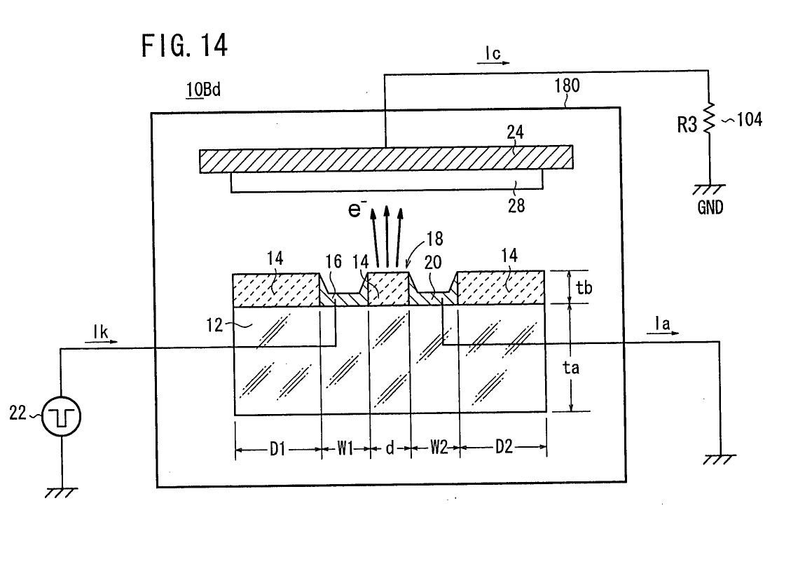

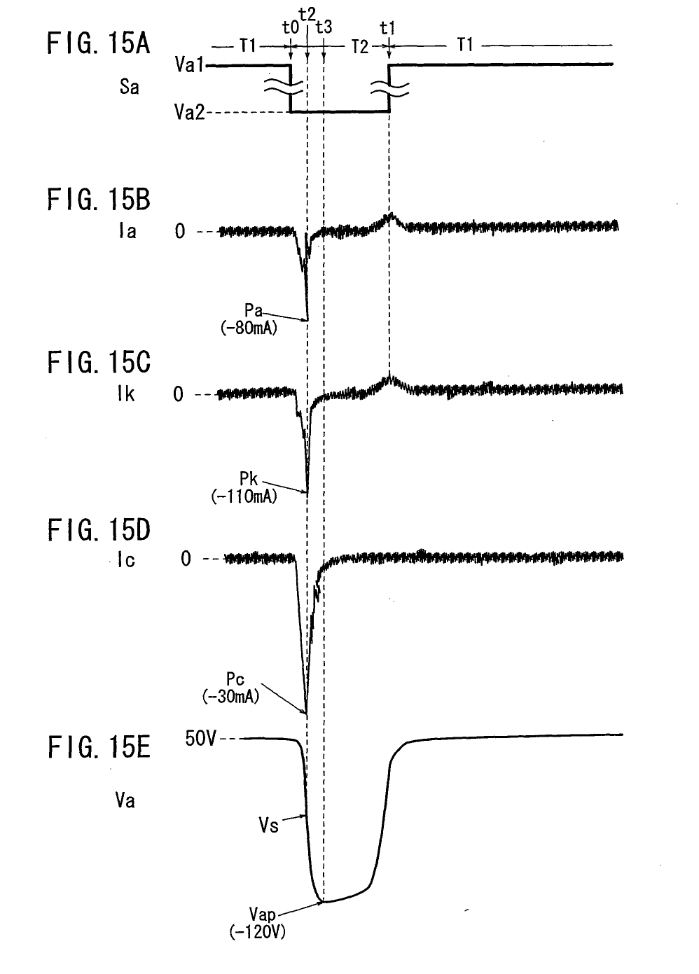

An experimental example with respect to electron emission will be described below. In this experimental example, a single electron emitter is placed as a sample 10Bd (see FIG. 14) in a vacuum chamber 180 (the vacuum level=4×10⁻³ Pa), and, when a drive signal Sa shown in FIG. 15A is supplied to the drive electrode 16, the waveforms of currents Ia, Ik, Ic flowing in respective parts of the electron emitter and the waveform of a voltage (applied voltage Va) applied between the drive electrode 16 and the common electrode 20 are measured. The measured waveforms are shown in FIGS. 15B through 15E.

As shown in FIG. 14, the sample 10Bd has the same structure as the electron emitter 10Bc (see FIG. 12) according to the third modification. The sample 10Bb is dimensioned as follows: The substrate 12 has a thickness ta of 140 μm. The electric field receiving member 14 has a thickness tb of 40 μm. The drive electrode 16 has a width W1 of 40 μm. The common electrode 20 has a width W2 of 40 μm. The slit 18 has a width d of 30 μm. The end of the drive electrode 16 (which is opposite to the end thereof in the slit 18) is spaced from a near side end of the electric field receiving member 14 by a distance D1 of 40 μm. The end of the common electrode 20 (which is opposite to the end thereof in the slit 18) is spaced from a near side end of the electric field receiving member 14 by a distance D2 of 40 μm.

Both the drive electrode 16 and the common electrode 20 are made of gold (Au), and the electric field receiving member 14 is made of PZT.

As shown in FIG. 15A, the drive signal Sa has a positive voltage Va1 of 50 V in the preparatory period T1. The drive signal Sa changes from the preparatory period T1 to the electron emission period T2 at a time t0. The drive signal Sa has a negative voltage Va2 of −120 V in the electron emission period T2. The drive signal Sa changes to the preparatory period T1 at a time t1.

FIG. 15B shows the measured waveform of the current Ia flowing from the common electrode 20 to GND. The current Ia has a peak Pa at a time t2 which is about 1 μsec. later than the time t0 of the negative-going edge of the drive signal Sa. The peak Pa has a value of about −80 mA.

FIG. 15C shows the measured waveform of the current Ik flowing from the pulse generation source 22 into the drive electrode 16. The current Ik has a peak Pk at the time t2 which is about 1 μsec. later than the time t0 as with the current Ia. The peak Pk has a value of about −110 mA.

FIG. 15D shows the measured waveform of the current Ic flowing from the electron collector electrode 24 to GND. The current Ic has a peak Pc at the time t2 which is about 1 μsec. later than the time t0 as with the currents Ia, Ik. The peak Pc has a value of about −30 mA.

FIG. 15E shows the measured waveform of the voltage Va applied between the drive electrode 16 and the common electrode 20. The voltage Va has a peak Vap at a time t3 which is about 2 μsec. later than the time t0 of the negative-going edge of the drive signal Sa. The peak Vap has a value of about −120 V.

In this experimental example, the applied voltage Va has a value of about 170 V at the, maximum for the purpose of reliably emitting electrons. According to the measured waveforms, electrons are emitted at the time t2 which is about 1 μsec. prior to the time t3 when the peak Vap of the applied voltage Va occurs, and the voltage Va has a value Vs of about −77 V at the time t2. The electron emission efficiency (Ic/Ik) at this time is 27%.

This indicates that the level of the applied voltage Va which is actually required to emit electrons is not as high as 170 V, but is 127 V to emit electrons, and that the applied voltage Va can be lowered to emit electrons.

The applied voltage Va may be lowered by optimizing the electron emitter 10 itself and also optimizing drive circuits therefor. The following description is aimed at optimization of drive circuits based on the present experimental example.

Drive circuits for the electron emitter 10 according to the present embodiment will be described below. For stably driving the electron emitter 10, i.e., for causing the electric field concentration point A (see FIG. 1) near the drive electrode 16 to emit electrons which serve as a source (trigger) for generating a plasma by applying a voltage to the drive electrode 16, it is necessary to apply a sharp voltage change to the drive electrode 16.

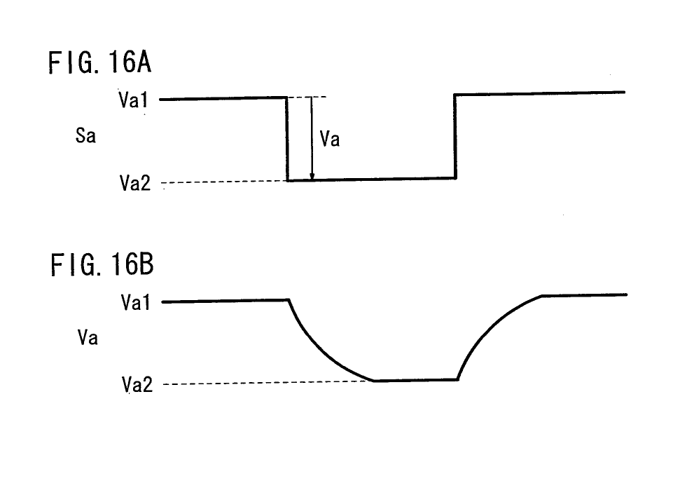

Usually, even when the drive signal Sa outputted from the pulse generation source 22 has a rectangular waveform as shown in FIG. 16A, the actual voltage (the applied voltage Va) applied between the drive electrode 16 and the common electrode 20 is of a gradual nature as a whole, as shown in FIG. 16B, due to the CR time constant based on the electrostatic capacitance C and other resistive component between the drive electrode 16 and the common electrode 20.

Of the waveform of the applied voltage Va, the voltage waveform immediately after the positive-going edge or negative-going edge of the drive signal Sa is relatively steep. However, the voltage level that rises or falls steeply is low, and the subsequent voltage waveform until the voltage level reaches 95%, for example, of a prescribed voltage (the amplitude Vin of the drive signal Sa) is gradual. An attempt may be made to obtain an apparent steep voltage change over a required voltage level by increasing the amplitude Vin of the drive signal Sa.

According to the above process, if the electron emitter 10 is regarded as a type of capacitor, then since the voltage (the applied voltage Va) applied between the drive electrode 16 and the common electrode 20 is increased, electrons are emitted by a high-speed charging with a large current. However, a subsequent application of a high voltage causes an excessive current to flow, tending to damage the drive electrode 16 owing to the Joule heat generated thereby and positive ions impinging upon the drive electrode 16.

According to the present embodiment, drive circuits according to various specific examples shown below are employed to reduce the size and cost of the electron emitter, lower the electron emission voltage, and minimize damage to the drive electrode 16 (and the common electrode 20) for a longer service life thereof.

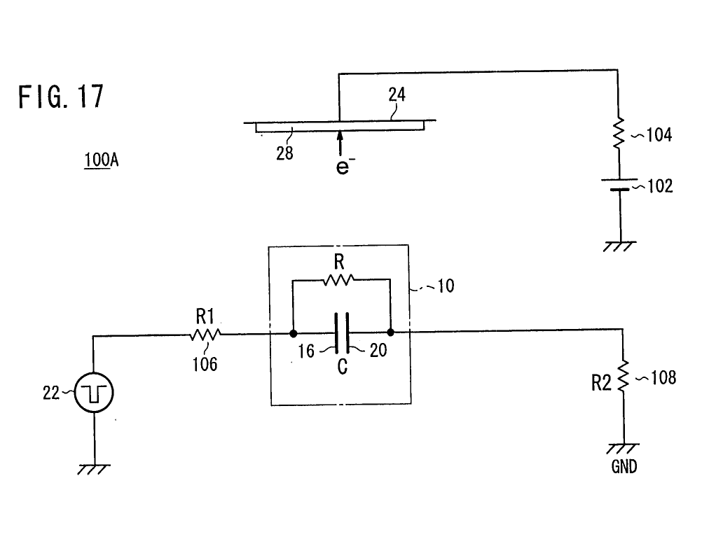

The electron emitter 10 (including various specific examples and modifications thereof) is applicable to drive circuits according to various specific examples described below. The electron emitter 10 is represented by a parallel circuit of a capacitor C and a resistor R in FIG. 17 and the subsequent figures.

As shown in FIG. 17, a drive circuit 100A according to a first specific example has a resistor 106 (resistance R1) connected between the drive electrode 16 and the pulse generation source 22, and a resistor 108 (resistance R2) connected between the common electrode 20 and a common potential generation source (GND in this example).

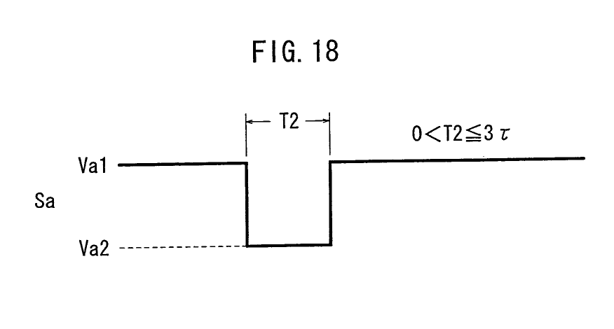

As shown in FIG. 18, the electron emission period T2 of the drive signal Sa is in a range 0<T2≦3τ where τ represents a time constant determined by the electrostatic capacitance C provided by the drive electrode 16 and the common electrode 20 and the resistors 106, 108.

The resistors 106, 108 are effective to suppress an excessive current flowing in the electron emitter 10. Since the electron emission period T2 is the period of a sharp voltage change which contributes to electron emission, a wasteful current supply is eliminated, resulting in a reduction of electric power consumption, and an emission of excessive electrons is suppressed, reducing damage to the drive electrode 16, etc.

In the above example, both the resistors 106, 108 are connected. However, only the resistor 106 or only the resistor 108 may be connected.

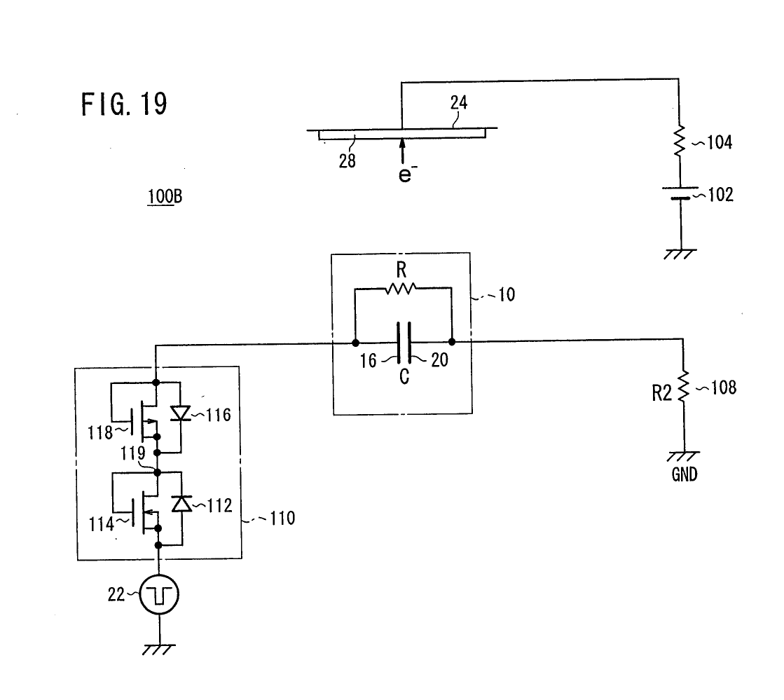

A drive circuit 100B according to a second specific example has essentially the same structure as the drive circuit 100A according to the first specific example, but differs therefrom in that the resistor 106 is replaced with a circuit 110 having nonlinear resistance characteristics, as shown in FIG. 19. The circuit 110 has an n-channel MOSFET (hereinafter referred to as n-MOSFET 114) including a drain-to-source protection diode 112 and a p-channel MOSFET (hereinafter referred to as p-MOSFET 118) including a drain-to-source protection diode 116, the n-MOSFET 114 and the p-MOSFET 118 being connected in series to each other. The drain of the n-MOSFET 114 and the source of the p-MOSFET 118 are connected to each other at a junction 119.

The n-MOSFET 114 has its gate connected to the junction 119, and the p-MOSFET 118 has its gate connected to the drain thereof.

When the source of the n-MOSFET 114 goes low at the start of the electron emission period T2, for example, a current flows from the electron emitter 10 through the diode 116 of the p-MOSFET 118 and the drain and source of the n-MOSFET 114.

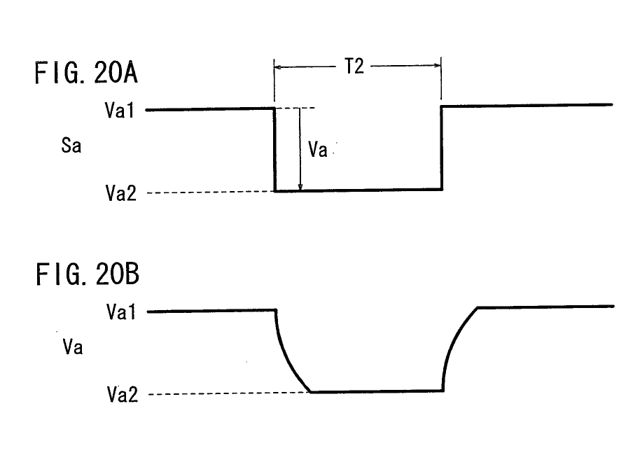

Because the current flows quickly due to the nonlinear resistance characteristics of the diode 116 and the n-MOSFET 114 at the start of the electron emission period T2, the voltage Va applied to the electron emitter 10 changes quickly from the positive voltage Va1 to the negative voltage Va2, as shown in FIG. 20B, thus providing a sharp voltage change. The drive electrode 16, therefore, emits electrons efficiently.

When the source of the n-MOSFET 114 goes high at the end of the electron emission period T2, a current flows from the pulse generation source 22 through the diode 112 of the n-MOSFET 114 and the drain and source of the p-MOSFET 118.

At this time, the current from the pulse generation source 22 flows quickly due to the nonlinear resistance characteristics of the diode 112 and the p-MOSFET 118 at the end of the electron emission period T2, the voltage Va applied to the electron emitter 10 changes quickly from the negative voltage Va2 to the positive voltage Va1, as shown in FIG. 20B.

Consequently, the circuit 110 is effective to quickly change the voltage Va applied to the electron emitter 10, and also to suppress an excessive current. The electron emission period T2 can be set to a shorter period than a case in which the resistor 106 is used, and hence the preparatory period T1 (see FIG. 3) can also be set to a shorter period. When the electron emitter 10 is applied to a pixel of a display, for example, therefore, the frequency of a horizontal synchronizing signal can be increased, or a high resolution can be achieved.

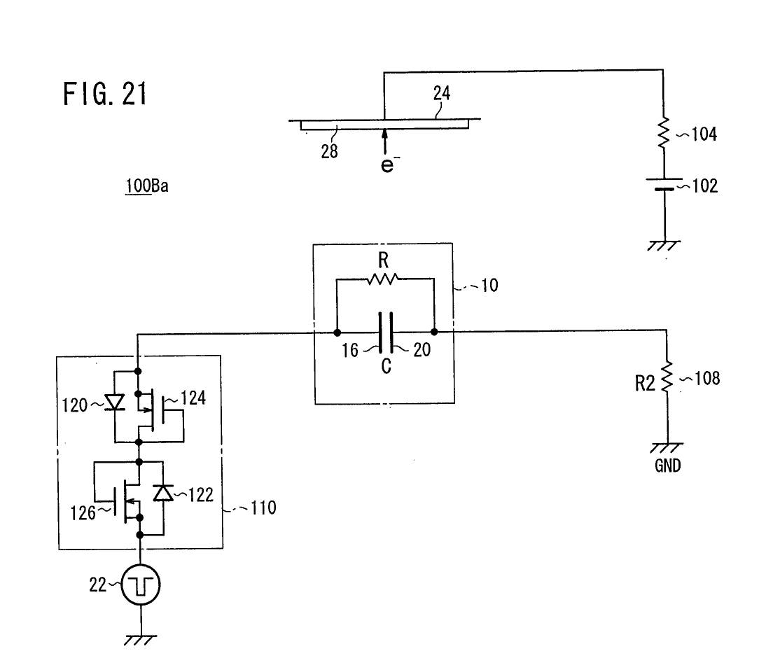

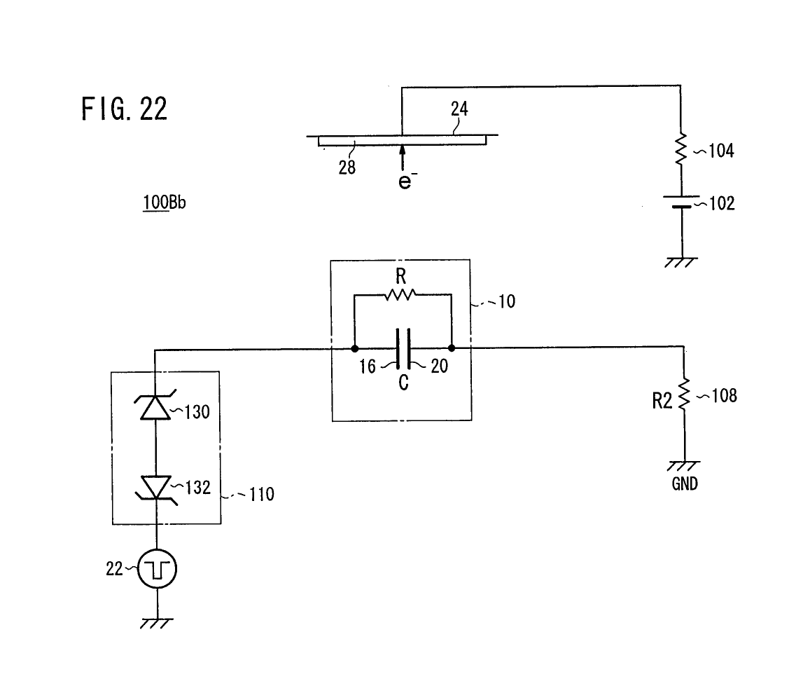

Two modifications of the drive circuit 100B according to the second specific example will be described below with reference to FIGS. 21 and 22.

A drive circuit 100Ba according to a first modification has essentially the same structure as the drive circuit 100B according to the second specific example, but differs therefrom in that, as shown in FIG. 21, the circuit 110 has two n-MOSFETs (first and second n-MOSFETs 124, 126) including respective drain-to-source protection diodes 120, 122 and connected in series to each other, with respective drains connected in common. The first and second n-MOSFETs 124, 126 have respective gates connected to the respective common drains.

According to the first modification, when the source of the second n-MOSFET 126 goes low at the start of the electron emission period T2, a current flows from the electron emitter 10 through the diode 120 of the first n-MOSFET 124 and the drain and source of the second n-MOSFET 126. When the source of the second n-MOSFET 126 goes high at the end of the electron emission period T2, a current flows from the pulse generation source 22 through the diode 122 of the second n-MOSFET 126 and the drain and source of the first n-MOSFET 124.

The circuit 110 shown in FIG. 21 is effective to quickly change the voltage Va applied to the electron emitter 10, and also to suppress an excessive current.

A drive circuit 100Bb according to a second modification has essentially the same structure as the drive circuit 100B according to the second specific example, but differs therefrom in that, as shown in FIG. 22, the circuit 110 has two zener diodes (first and second zener diodes 130, 132) connected in series to each other, with respective anodes connected in common. The first and second zener diodes 130, 132 have respective zener voltages set to 50 V, for example.

According to the second modification, when the cathode of the second zener diode 132 goes low at the start of the electron emission period T2, the first zener diode 130 is rendered conductive, allowing a current to flow from the electron emitter 10 through the first and second zener diodes 130, 132. At this time, the current flows quickly due to the nonlinear resistance characteristics of the second zener diode 132, so that the voltage Va applied to the electron emitter 10 changes sharply.

When the cathode of the second zener diode 132 goes high at the end of the electron emission period T2, the second zener diode 132 is rendered conductive, allowing a current to flow from the pulse generation source 22 through the first and second zener diodes 130, 132.

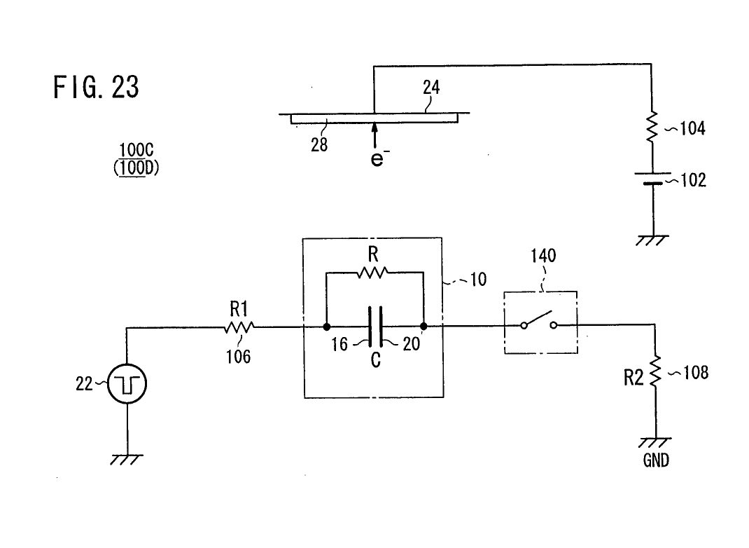

A drive circuit 100C according to a third specific example will be described below with reference to FIG. 23. The drive circuit 100C according to the third specific example has essentially the same structure as the drive circuit 100A according to the first specific example, but differs therefrom in that it has a switching element 140 connected in series to the electron emitter 10. The resistor 106 may be replaced with the circuit 110 shown in FIG. 19, 21, or 22.

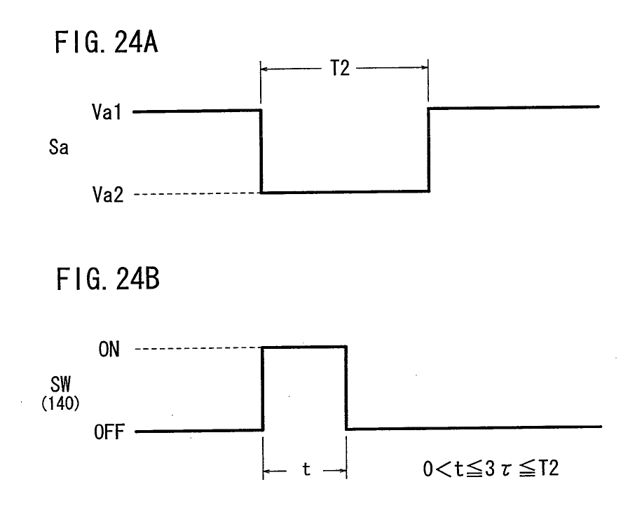

As shown in FIGS. 24A and 24B, if τ represents a time constant determined by the electrostatic capacitance C provided by the drive electrode 16 and the common electrode 20 and the resistors 106, 108, T2 the electron emission period, and t the on-time of the switching element 140, then the time constant τ, the electron emission period T2, and the on-time t satisfy the relationship: 0<t≦3τ≦T2.

In this case, since the switching element 140 is turned on in the period of a sharp voltage change which contributes to electron emission, a wasteful current supply is eliminated, resulting in a reduction of electric power consumption, and an emission of excessive electrons is suppressed.

If the resistor 106 is replaced with the circuit 110 shown in FIG. 19, 21, or 22, then the on-time t and the electron emission period T2 can be made shorter.

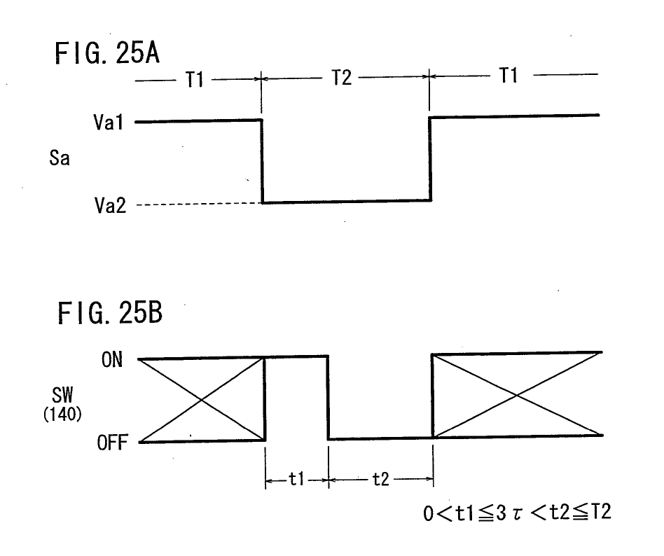

As shown in FIG. 23, a drive circuit 100D according to a fourth specific example has essentially the same structure as the drive circuit 100C according to the third specific example, but differs therefrom in that, as shown in FIGS. 25A and 25B, if an on-time of the switching element 140 for emitting electrons is represented by t1, and a subsequent off-time of the switching element 140 for keeping electrons emitted and suppressing a current flowing into the drive electrode is represented by t2, then these times are set in the range: 0<t1≦3τ<t2≦T2. In the preparatory period T1, the switching element 140 is in an arbitrary state (on or off).

In the on-time t1 of the switching element 140, a sharp voltage change contributing to electron emission occurs, and in the off-time t2, the electron emission is kept and the current flowing into the drive electrode 16 is suppressed. Therefore, a wasteful current supply is eliminated, resulting in a reduction of electric power consumption, and an emission of excessive electrons is suppressed.

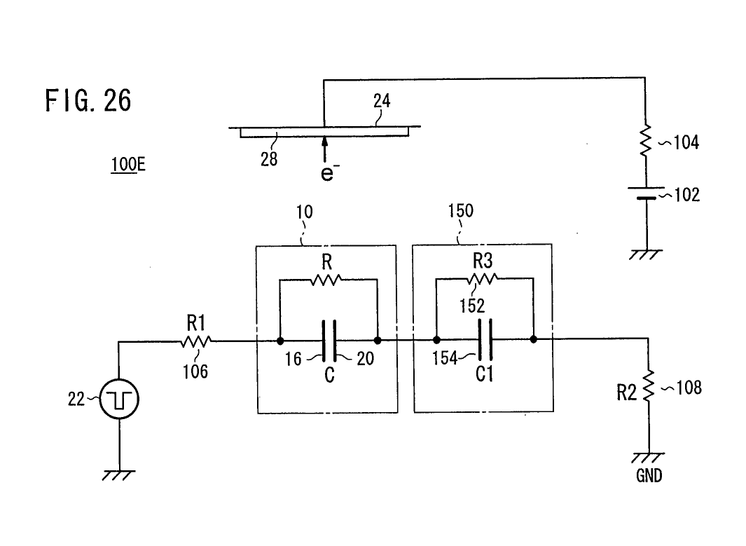

As shown in FIG. 26, a drive circuit 100E according to a fifth specific example has a single parallel circuit 150 connected in series to the electron emitter 10. The parallel circuit 150 comprises a resistor 152 and a capacitor 154 which are connected parallel to each other.

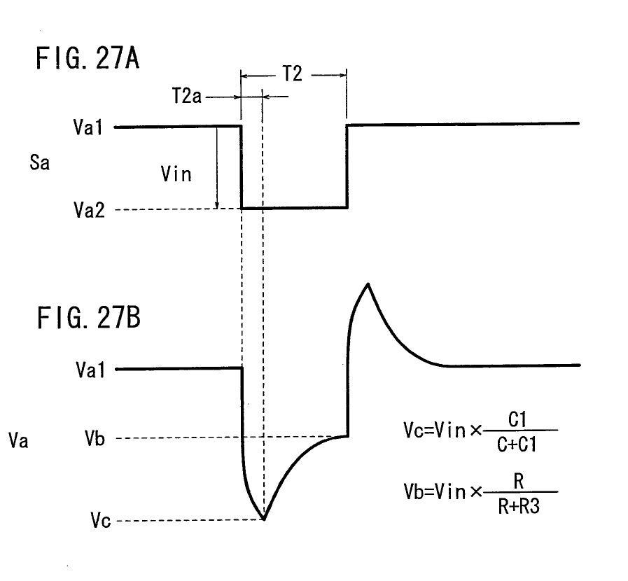

As shown in FIGS. 27A and 27B, of the electron emission period T2, an effective electron emission period T2a in which electrons are actually emitted is a period from the start of the pulse of the drive signal Sa to the time when the level of the voltage Va applied to the electron emitter 10 reaches a divided level Vc on the electron emitter 10 of the amplitude Vin of the drive signal.

Specifically, if it is assumed that the amplitude of the drive signal Sa from the pulse generation source 22 is represented by Vin, the electrostatic capacitance between the drive electrode 16 and the common electrode 20 by C, the capacitance of the capacitor 154 of the parallel circuit 150 by C1, the resistance of the electron emitter 10 by R, and the resistance of the resistor 152 of the parallel circuit 150 by R3, then the effective electron emission period T2a is a time in which the level of the voltage Va applied between the drive electrode 16 and the common electrode 20 changes from a high level Vb to a low level Vc=Vin×{C1/(C+C1)} where the high level Vb=Vin×{R/(R+R3)}.

Immediately after elapse of the effective electron emission period T2a, the applied voltage Va changes quickly and then gradually toward the high level Vb, and finally reaches the high level Vb when the electron emission period T2 elapses.

Since the capacitor 154 of the parallel circuit 150 is connected in series to the electrostatic capacitance C formed by the drive electrode 16 and the common electrode 20 of the electron emitter 10, the overall capacitance becomes smaller than the electrostatic capacitance C formed by the drive electrode 16 and the common electrode 20, and the CR time constant becomes smaller accordingly. As a result, there is obtained a voltage change going quickly up to a voltage level (Vin×{C1/(C+C1)} which is required for emitting electrons as the applied voltage Va, so that the electron emission voltage can be lowered.

Inasmuch as the absolute value of the applied voltage Va is reduced at the same time that the electron emission period T2 is finished, an excessive current is suppressed, reducing damage to the drive electrode 16 and the common electrode 20 for a longer service life thereof.

With the drive circuit 100E according to the fifth specific example, since the applied voltage Va reaches the level Vin×{R/(R+R3)} after elapse of the effective electron emission period T2a, it is preferable to bring the level Vin×{R/(R+R3)} closely to 0 if the dynamic range of the applied voltage Va is to be increased.

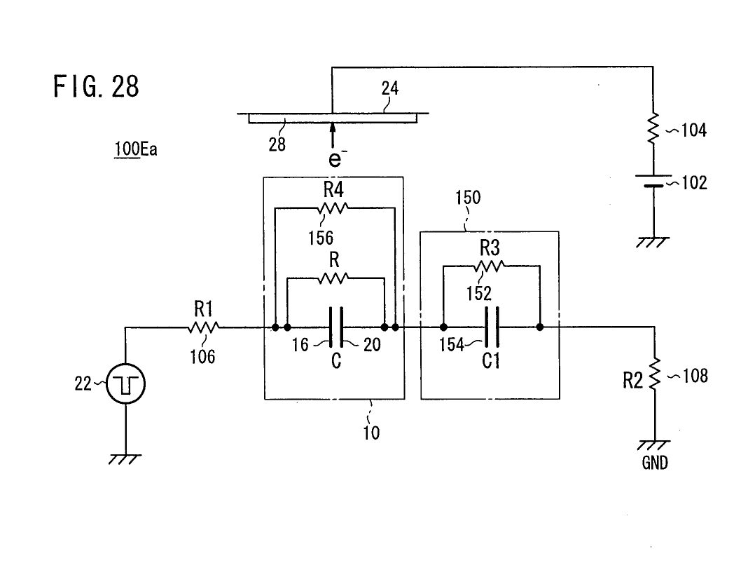

Ideally, the resistance R3 of the resistor 152 of the parallel circuit 150 may be set to infinity, but doing so tends to reduce the freedom with which to select the resistor 152. According to a solution, a drive circuit 100Ea according to a modification shown in FIG. 28 has a resistor 156 of a low resistance R4 connected parallel to the resistance (resistance R) of the electron emitter 10. Since the resistor 156 thus connected lowers the combined resistance of the electron emitter 10, the freedom with which to select the resistor 152 of the parallel circuit 150 can be increased.

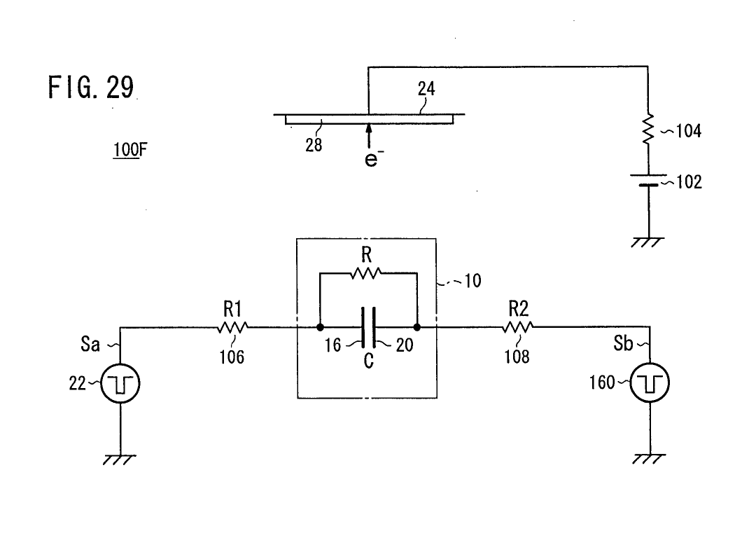

A drive circuit 100F according to a sixth specific example has essentially the same structure as the drive circuit 100A according to the first specific example, but differs therefrom in that, as shown in FIG. 29, a pulse generation circuit 160 is connected to the common electrode 20 for applying a voltage which has an opposite polarity to the voltage applied to the drive electrode 16 at least in the electron emission period T2.

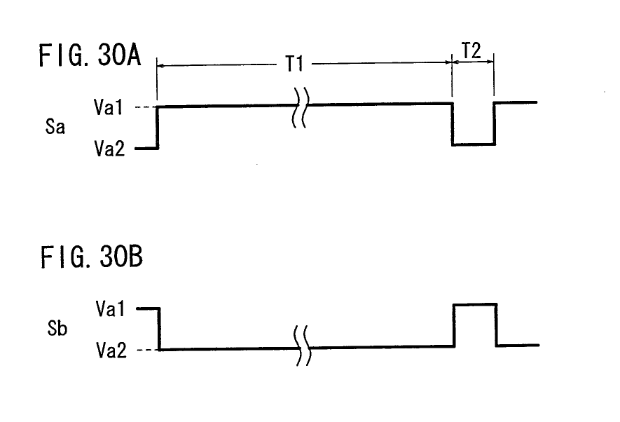

Specifically, as shown in FIGS. 30A and 30B, in the preparatory period T1, the pulse generation source 22 outputs a voltage Va1 of 30 V, and the pulse generation circuit 160 outputs a voltage Va2 of −100V. In the electron emission period T2, the pulse generation source 22 outputs a voltage Va2 of −100 V, and the pulse generation circuit 160 outputs a voltage Va1 of 30 V.

If the common electrode 20 is under a constant potential and the drive electrode 16 is supplied with the drive signal Sa, then the dynamic range of the voltage Va applied between the drive electrode 16 and the common electrode 20 is determined by the withstand voltage of the pulse generation source 22.

However, the pulse generation circuit 160 is effective to increase the dynamic range of the voltage Va applied between the drive electrode 16 and the common electrode 20 to a withstand voltage which is the sum of the withstand voltage of the pulse generation source 22 and the withstand voltage of the pulse generation circuit 160. In the example shown in FIGS. 30A and 30B, the voltage Va applied to the electron emitter 10 in the electron emission period T2 is 260 V.

This means that, if the voltage Va applied to the electron emitter 10 in the electron emission period T2 is 130 V, then a circuit having a withstand voltage which is one-half (65 V in this example) the above normal withstand voltage may be used as the pulse generation source 22 and the pulse generation circuit 160. Therefore, the drive circuit 100F can be made smaller in size and lower in cost.

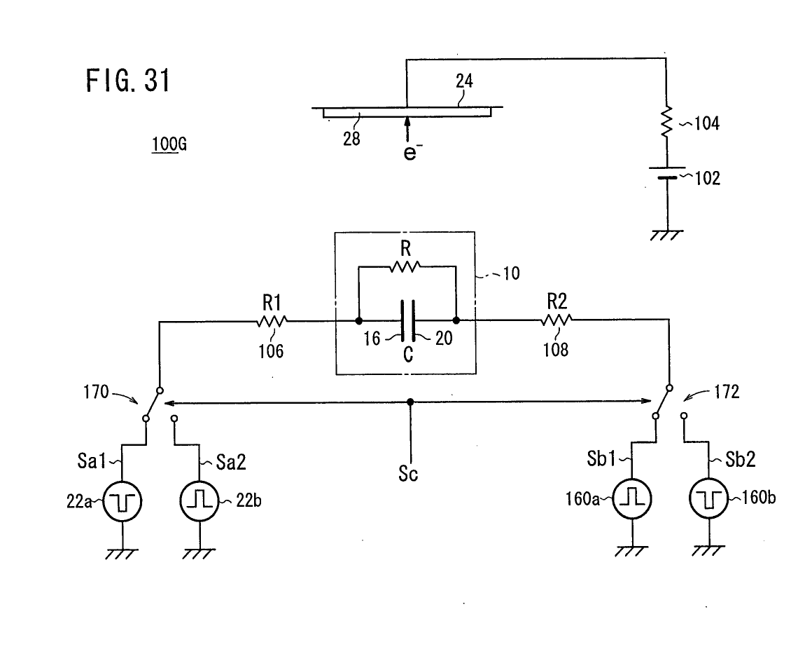

A drive circuit 100G according to a seventh specific example will be described below with reference to FIG. 31. The drive circuit 100G according to the seventh specific example has essentially the same structure as the drive circuit 100F according to the sixth specific example, but differs therefrom in that it has two pulse generation sources (first and second pulse generation sources 22a, 22b) for supplying a drive signal to the drive electrode 16, a first switching circuit 170 for switching the pulse generation sources 22a, 22b based on a switching control signal Sc two pulse generation circuits (first and second pulse generation circuits 160a, 160b) for supplying a drive signal to the common electrode 20, and a second switching circuit 172 for switching the pulse generation circuits 160a, 160b based on the switching control signal Sc.

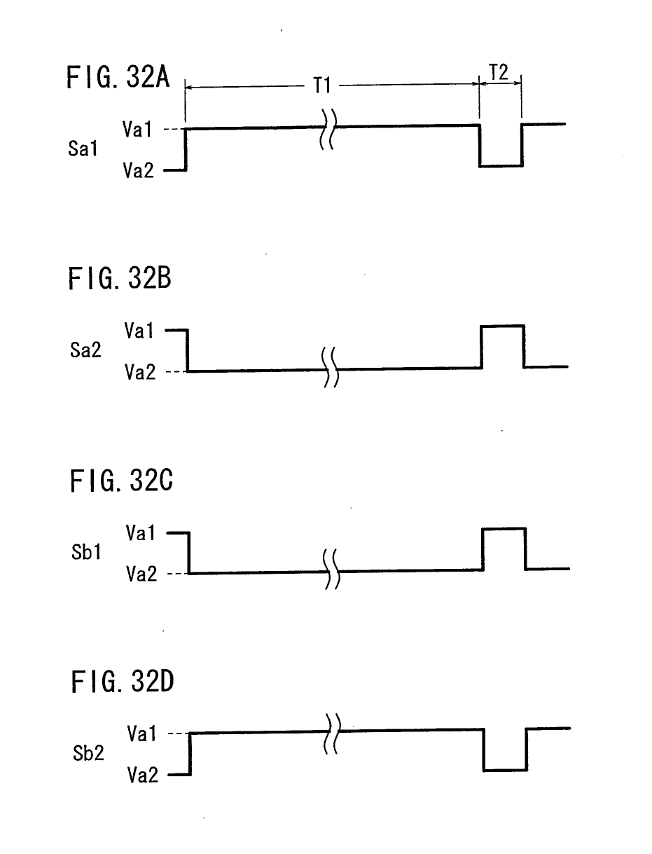

The first pulse generation source 22a outputs a drive signal Sa1 having such a voltage waveform that, as shown in FIG. 32A, a positive voltage Val (e.g., 30 V) is applied to the drive electrode 16 in the preparatory period T1 and a negative voltage Va2 (e.g., −100 V) is applied to the drive electrode 16 in the electron emission period T2.

The second pulse generation source 22b outputs a drive signal Sa2 having such a voltage waveform that, as shown in FIG. 32B, a negative voltage Va2 (e.g., −100 V) is applied to the drive electrode 16 in the preparatory period T1, and a positive voltage Va1 (e.g., 30 V) is applied to the drive electrode 16 in the electron emission period T2.

The first pulse generation circuit 160a outputs a drive signal Sb1 having such a voltage waveform that, as shown in FIG. 32C, a negative voltage Va2 (e.g., −100 V) is applied to the common electrode 20 in the preparatory period T1 and a positive voltage Va1 (e.g., 30 V) is applied to the common electrode 20 in the electron emission period T2.

The second pulse generation circuit 160b outputs a drive signal Sb2 having such a voltage waveform that, as shown in FIG. 32D, a positive voltage Va1 (e.g., 30 V) is applied to the common electrode 20 in the preparatory period T1, and a negative voltage Va2 (e.g., −100 V) is applied to the common electrode 20 in the electron emission period T2.

The first and second switching circuits 170, 172 are ganged switching circuits for performing their switching operation based on one switching control signal Sc. The switching control signal Sc may comprise a command signal from a computer or a timer, for example. In the present specific example, the switching circuits 170, 172 are operated by voltage levels (a high level and a low level) of the switching control signal Sc.

When the first and second switching circuits 170, 172 select the first pulse generation source 22a and the first pulse generation circuits 160, respectively, with the switching control signal Sc (e.g., a high voltage level), the positive voltage Va1 is applied to the drive electrode 16 in the preparatory period T1, polarizing the electric field receiving member 14, and the negative voltage Va2 is applied to the drive electrode 16 in the electron emission period T2, inverting the polarization of the electric field receiving member 14 thereby to enable the drive electrode 16 to emit electrons.

If the above sequence is regarded as one step, then the step is carried out once or a plurality of times while the switching control signal Sc is a high level, thus performing one cycle (first cycle) of operation.

Conversely, when the first and second switching circuits 170, 172 select the second pulse generation source 22b and the second pulse generation circuits 160b, respectively, with the switching control signal Sc (e.g., a low voltage level), the positive voltage Va1 is applied to the common electrode 20 in the preparatory period T1, polarizing the electric field receiving member 14, and the negative voltage Va2 is applied to the common electrode 20 in the electron emission period T2, inverting the polarization of the electric field receiving member 14 thereby to enable the common electrode 20 to emit electrons.

If the above sequence is regarded as one step, then the step is carried out once or a plurality of times while the switching control signal Sc is a low level, thus performing one cycle (second cycle) of operation.

Based on a command signal from a computer or a timer, the first and second switching circuits 170, 172 can switch between the first cycle and the second cycle in every step or every several steps as desired.

If the electron emitter 10 were energized in the first cycle only, then positive ions generated by the plasma would impinge upon the drive electrode 16, damaging the drive electrode 16 only. Therefore, the durability of the electron emitter 10 would hinge only upon damage to the drive electrode 16. If the electron emitter 10 were energized in the second cycle only, then the durability of the electron emitter 10 would hinge only upon damage to the common electrode 20.

According to the present specific example, the first cycle and the second cycle are switched or selected as desired to distribute damage, which would otherwise be caused to one of the electrodes, to both the electrodes, with the result that the electrodes will have a longer service life.

The drive circuits 100A through 100G according to the first through seventh specific examples are arranged mainly for the purpose of suppressing excessive currents. If the electron emitter 10 is used as a pixel of a display, therefore, there may be a limitation posed on efforts to increase the luminance of the pixel.

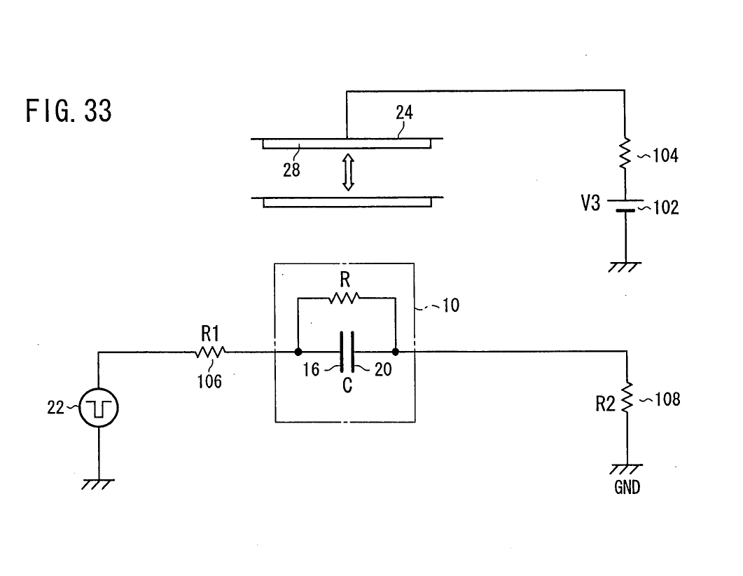

According to one solution, as shown in FIG. 33, the electron collector electrode 24 associated with the electron emitter 10 whose luminance may possibly be limited is moved toward the slit 18 of the electron emitter 10, or the voltage V3 of the bias voltage source 102, which is applied to the electron collector electrode 24, is increased.

The electron emitter, the circuit for driving the electron emitter, and the method of driving the electron emitter according to the present invention are not limited to the above embodiments, but may be embodied in various arrangements without departing from the scope of the present invention.

What is claimed is:

1. An electron emitter comprising:
an electric field receiving member made of a dielectric material;
a drive electrode for being supplied with a drive signal, said drive electrode being formed in contact with said electric field receiving member; and
a common electrode formed in contact with said electric field receiving member, with a slit defined between said drive electrode and said common electrode;
said slit having a width ranging from 1 μm to 50 μm.

2. An electron emitter according to claim 1, wherein the width of said slit ranges from 0.1 μm to 10 μm.

3. An electron emitter according to claim 1, wherein the width of said slit ranges from 0.1 μm to 1 μm.

4. An electron emitter according to claim 1, wherein said drive electrode and said common electrode are formed on an upper surface of said electric field receiving member, said slit comprising a gap.

5. An electron emitter according to claim 1, wherein said drive electrode is formed in contact with one side surface of said electric field receiving member, and said common electrode is formed in contact with another side surface of said electric field receiving member, said electric field receiving member being present in said slit.

6. An electron emitter according to claim 5, wherein said electric field receiving member is formed in a tortuous pattern.

7. An electron emitter comprising:
an electric field receiving member made of a dielectric material;
a drive electrode for being supplied with a drive signal, said drive electrode being formed in contact with one side surface of said electric field receiving member; and
a common electrode formed in contact with another side surface of said electric field receiving member, with a slit defined between said drive electrode and said common electrode;
said electric field receiving member being present in said slit.

8. A drive circuit of an electron emitter having an electric field receiving member made of a dielectric material, a drive electrode for being supplied with a drive signal, said drive electrode being formed in contact with said electric field receiving member, and a common electrode formed in contact with said electric field receiving member, with a slit defined between said drive electrode and said common electrode, said circuit comprising:
a capacitor connected between a source for generating said drive signal and said drive electrode and/or between said common electrode and a source for generating a common potential.

9. A drive circuit of an electron emitter having an electric field receiving member made of a dielectric material, a drive electrode for being supplied with a drive signal, said drive electrode being formed in contact with said electric field receiving member, and a common electrode formed in contact with said electric field receiving member, with a slit defined between said drive electrode and said common electrode, said circuit comprising:
a current-suppressing resistive device connected between a source for generating said drive signal and said drive electrode and/or between said common electrode and a source for generating a common potential.

10. A drive circuit according to claim 9, wherein said resistive device has nonlinear resistance characteristics.

11. A drive circuit according to claim 10, wherein said resistive device comprises a MOSFET.

12. A drive circuit according to claim 8, wherein said source for generating the drive signal repeats a step comprising a preparatory period in which a positive voltage is applied to said drive electrode to polarize said electric field receiving member and an electron emission period in which a negative voltage is applied to said drive electrode to invert the polarization of said electric field receiving member for emitting electrons.

13. A drive circuit according to claim 12, wherein said negative voltage has an absolute value greater than said positive voltage.

14. A drive circuit according to claim 8, further comprising a switching circuit for switching between a first cycle and a second cycle, said first cycle including at least one step which comprises a preparatory period in which a positive voltage is applied to said drive electrode to polarize said electric field receiving member and an electron emission period in which a negative voltage is applied to said drive electrode to invert the polarization of said electric field receiving member for emitting electrons from said drive electrode, and said second cycle including at least one step which comprises a preparatory period in which a negative voltage is applied to said drive electrode to polarize said electric field receiving member and an electron emission period in which a positive voltage is applied to said drive electrode to invert the polarization of said electric field receiving member for emitting electrons from said common electrode.

15. A drive circuit according to claim 12, further comprising a pulse generation circuit for applying a voltage which has an opposite polarity to the voltage applied to said drive voltage, to said common electrode at least in said electron emission period.

16. A drive circuit according to claim 12, wherein said electron emission period ranges from 5 to 10 μsec., and said preparatory period is longer than said electron emission period.

17. A drive circuit according to claim 12, wherein if a time constant determined by an electrostatic capacitance and other resistive component between said drive electrode and said common electrode is represented by τ and said electron emission period by T, then said time constant τ and said electron emission period T satisfy the following relationship:
0≦T≦3τ.

18. A drive circuit according to claim 12, further comprising a switching element connected in series to said electron emitter, wherein if a time constant determined by an electrostatic capacitance and other resistive component between said drive electrode and said common electrode is represented by τ, said electron emission period by T, and an on-time of said switching element by t, then said time constant τ, said electron emission period T, and said on-time t satisfy the following relationship:
0≦t≦3τ≦T.

19. A drive circuit according to claim 18, wherein if an on-time of said switching element for emitting electrons is represented by t1, and a subsequent off-time of said switching element for keeping electrons emitted and suppressing a current flowing into said drive electrode by t2, then said time constant τ, said electron emission period T, said on-time t1, and said off-time t2 satisfy the following relationship:
0≦t1≦3τ<t2≦T.

20. A drive circuit according to claim 12, further comprising at least one parallel circuit connected in series to said electron emitter, said parallel circuit comprising a resistor and a capacitor which are connected parallel to each other, wherein said electron emission period includes an effective electron emission period from the start of a pulse of said drive signal to the time when the level of the voltage applied to the electron emitter reaches a divided level on the electron emitter of the amplitude of said drive signal.

21. A method of driving an electron emitter having an electric field receiving member made of a dielectric material, a drive electrode for being supplied with a drive signal, said drive electrode being formed in contact with said electric field receiving member, and a common electrode formed in contact with said electric field receiving member, with a slit defined between said drive electrode and said common electrode, said method comprising repeating a step which comprises a preparatory period in which a positive voltage is applied to said drive electrode to polarize said electric field receiving member and an electron emission period in which a negative voltage is applied to said drive electrode to invert the polarization of said electric field receiving member for emitting electrons.

22. A method according to claim 21, wherein said negative voltage has an absolute value greater than said positive voltage.

23. A method according to claim 21, further comprising switching between a first cycle and a second cycle, said first cycle including at least one step which comprises a preparatory period in which a positive voltage is applied to said drive electrode to polarize said electric field receiving member and an electron emission period in which a negative voltage is applied to said drive electrode to invert the polarization of said electric field receiving member for emitting electrons from said drive electrode, and said second cycle including at least one step which comprises a preparatory period in which a negative voltage is applied to said drive electrode to polarize said electric field receiving member and an electron emission period in which a positive voltage is applied to said drive electrode to invert the polarization of said electric field receiving member for emitting electrons from said common electrode.

24. A method according to claim 21, further comprising applying a voltage which has an opposite polarity to the voltage applied to said drive voltage, to said common electrode at least in said electron emission period.

25. A method according to claim 21, wherein said electron emission period ranges from 5 to 10 μsec., and said preparatory period is longer than said electron emission period.

26. A method according to claim 21, wherein if a time constant determined by an electrostatic capacitance and other resistive component between said drive electrode and said common electrode is represented by τ and said electron emission period by T, then said time constant τ and said electron emission period T satisfy the following relationship:
0≦T≦3τ.

27. A method according to claim 21, wherein a switching element is connected in series to said electron emitter, and if a time constant determined by an electrostatic capacitance and other resistive component between said drive electrode and said common electrode is represented by τ, said electron emission period by T, and an on-time of said switching element by t, then said time constant τ, said electron emission period T, and said on-time t satisfy the following relationship:
0≦t≦3τ≦T.

28. A method according to claim 27, wherein if an on-time of said switching element for emitting electrons is represented by t1, and a subsequent off-time of said switching element for keeping electrons emitted and suppressing a current flowing into said drive electrode by t2, then said time constant τ, said electron emission period T, said on-time t1, and said off-time t2 satisfy the following relationship:
0≦t1≦3τ<t2≦T.

29. A method according to claim 21, wherein at least one parallel circuit is connected in series to said electron emitter, said parallel circuit comprising a resistor and a capacitor which are connected parallel to each other, and wherein said electron emission period includes an effective electron emission period from the start of a pulse of said drive signal to the time when the level of the voltage applied to the electron emitter reaches a divided level on the electron emitter of the amplitude of said drive signal.
